(19) United States
(12) Patent Application Publication
(10) Pub. No.: US 2006/0117352 A1
(43) Pub. Date: Jun. 1, 2006

(54) Search table for metadata of moving picture

(76) Inventors: Yoichiro Yamagata, Yokohama-shi (JP); Yasufumi Tsumagari, Yokohama-shi (JP); Toshimitsu Kaneko, Kawasaki-shi (JP); Tooru Kamibayashi, Chigasaki-shi (JP); Hiroshi Isozaki, Kawasaki-shi (JP); Hideki Takahashi, Kashiwa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/237,794

(22) Filed: Sep. 29, 2005

(30) Foreign Application Priority Data
Sep. 30, 2004 (JP) 2004-287916

(51) Int. Cl. H04N 7/16

(52) U.S. Cl. 725/50; 725/25

(57) ABSTRACT

This invention can efficiently execute processing that combines a moving picture at a viewer and metadata at the viewer or on a network. Metadata has data that specifies a lifetime, object region data that describes a spatio-temporal region in the moving picture, related attribute information, and the like, and includes one or more Vclick access units which are data units that can be processed independently. Vclick data includes a search table used to access the metadata.

### CROSS-REFERENCE TO RELATED APPLICATIONS

This application is based upon and claims the benefit of priority from prior Japanese Patent Application No. 2004-287916, filed Sep. 30, 2004, the entire contents of which are incorporated herein by reference.

### BACKGROUND OF THE INVENTION

1. Field of the Invention

The present invention relates to a method of implementing moving picture hypermedia by combining moving picture data in a client and metadata from a network (or a disc), and superimposing an on-screen display (OSD) and balloon tact on a moving picture.

2. Description of the Related Art

Hypermedia define relationships called hyperlinks among media such as a moving picture, still picture, audio, text, and the like so as to allow these media to refer to each other or from one to another. For example, text data and still picture data are allocated on a web page which can be browsed using the World Wide Web and is described in HTML, and links are defined between all these text data and still picture data. By designating such links, related information at a link destination can be immediately displayed. Since the user can access related information by directly designating a phrase that appeals to him or her, easy and intuitive operation is allowed.

On the other hand, in hypermedia that mainly include moving picture data in place of text and still picture data, links from objects such as persons, articles, and the like that appear in the moving picture to related content such as their text data, still picture data that explain them are defined. When a viewer designates an object, the related content is displayed. At this time, in order to define a link between the spatio-temporal region of an object that appears in the moving picture and related content, data (object region data) indicating the spatio-temporal region of the object in the moving picture is required.

As the object region data, a mask image sequence having two or more values, arbitrary shape encoding of MPEG-4, a method of describing the loci of feature points of a figure, as described in Jpn. Pat. Appln. KOKAI Publication No. 2000-285253, a method described in Jpn. Pat. Appln. KOKAI Publication No. 2001-111996, and the like may be used. In order to implement hypermedia that mainly include moving picture data, data (action information) that describes an action for displaying other related content upon designation of an object is required in addition to the above data. These data other than the moving picture data will be referred to as metadata hereinafter.

As a method of providing moving picture data and metadata to a viewer, a method of preparing a recording medium (video CD, DVD, or the like) that records both moving picture data and metadata is available. In order to provide metadata of moving picture data that has already been owned as a video CD or DVD, only metadata can be downloaded or distributed by streaming from the network. Both moving picture data and metadata may be distributed via the network. At this time, metadata preferably has a format that can efficiently use a buffer, is suited to random access, and is robust against any data loss in the network.

When moving picture data are switched frequently (e.g., when moving picture data captured at a plurality of camera angles are prepared, and a viewer can freely select an arbitrary camera angle; like multi-angle video of DVD-Video), metadata must be quickly switched in correspondence with switching of moving picture data.

### BRIEF SUMMARY OF THE INVENTION

Moving picture metadata according to an embodiment of the present invention has information associated with an effective time interval (lifetime) defined for the time axis of a moving picture, data that specifies the lifetime, object region data that describes a spatio-temporal region in the moving image, and data that specifies a display method related to the spatio-temporal region, and/or data that specifies a process to be executed when the spatio-temporal region is designated. The metadata is formed by including one or more access units (Vclick_AU) as data units that can be processed independently.

The moving picture metadata according to an embodiment of the present invention can have a table (VCKSRCT.IFO) that covers keywords related to individual objects. Using this table, when the user searches all metadata for information to be acquired, he or she can access metadata (Vclick data) that records the corresponding information.

Also, in order to access target Vclick data more quickly, the metadata can have a playback start time and the like of Vclick data as attribute information.

Since the metadata is formed as a set of access units (Vclick_AU) that can be processed independently, it efficiently uses the buffer, facilitates easy random access, reduces the influence of a data loss, and allows high-speed switching of metadata. Furthermore, quick access to metadata (Vclick data) can be made.

### BRIEF DESCRIPTION OF THE SEVERAL VIEWS OF THE DRAWING

FIG. 1 is a view for explaining a display example of hypermedia according to an embodiment of the present invention;

FIG. 2 is a block diagram showing an example of the arrangement of a system according to the embodiment of the present invention;

FIG. 3 is a view for explaining the relationship between an object region and object region data according to the embodiment of the present invention;

FIG. 4 is a view for explaining an example of the data structure of an access unit of object metadata according to the embodiment of the present invention;

FIG. 5 is a view for explaining a method of forming a Vclick stream according to the embodiment of the present invention;

FIG. 6 is a view for explaining an example of the configuration of a Vclick access table according to the embodiment of the present invention;

FIG. 7 is a view for explaining an example of the configuration of a transmission packet according to the embodiment of the present invention;

FIG. 8 is a view for explaining another example of the configuration of a transmission packet according to the embodiment of the present invention;

FIG. 9 is a chart for explaining an example of communications between a server and client according to the embodiment of the present invention;

FIG. 10 is a chart for explaining another example of communications between a server and client according to the embodiment of the present invention;

FIG. 11 is a table for explaining an example of data elements of a Vclick stream according to the embodiment of the present invention;

FIG. 12 is a table for explaining an example of data elements of a header of the Vclick stream according to the embodiment of the present invention;

FIG. 13 is a table for explaining an example of data elements of a Vclick access unit (AU) according to the embodiment of the present invention;

FIG. 14 is a table for explaining an example of data elements of a header of the Vclick access unit (AU) according to the embodiment of the present invention;

FIG. 15 is a table for explaining an example of data elements of a time stamp of the Vclick access unit (AU) according to the embodiment of the present invention;

FIG. 16 is a table for explaining an example of data elements of a time stamp skip of the Vclick access unit (AU) according to the embodiment of the present invention;

FIG. 17 is a table for explaining an example of data elements of object attribute information according to the embodiment of the present invention;

FIG. 18 is a table for explaining an example of types of object attribute information according to the embodiment of the present invention;

FIG. 19 is a table for explaining an example of data elements of a name attribute of an object according to the embodiment of the present invention;

FIG. 20 is a table for explaining an example of data elements of an action attribute of an object according to the embodiment of the present invention;

FIG. 21 is a table for explaining an example of data elements of a contour attribute of an object according to the embodiment of the present invention;

FIG. 22 is a table for explaining an example of data elements of a blinking region attribute of an object according to the embodiment of the present invention;

FIG. 23 is a table for explaining an example of data elements of a mosaic region attribute of an object according to the embodiment of the present invention;

FIG. 24 is a table for explaining an example of data elements of a paint region attribute of an object according to the embodiment of the present invention;

FIG. 25 is a table for explaining an example of data elements of text information data of an object according to the embodiment of the present invention;

FIG. 26 is a table for explaining an example of data elements of a text attribute of an object according to the embodiment of the present invention;

FIG. 27 is a table for explaining an example of data elements of a text highlight effect attribute of an object according to the embodiment of the present invention;

FIG. 28 is a table for explaining an example of data elements of an entry of a text highlight effect attribute of an object according to the embodiment of the present invention;

FIG. 29 is a table for explaining an example of data elements of a text blinking effect attribute of an object according to the embodiment of the present invention;

FIG. 30 is a table for explaining an example of data elements of an entry of a text blinking effect attribute of an object according to the embodiment of the present invention;

FIG. 31 is a table for explaining an example of data elements of a text scroll effect attribute of an object according to the embodiment of the present invention;

FIG. 32 is a table for explaining an example of data elements of a text karaoke effect attribute of an object according to the embodiment of the present invention;

FIG. 33 is a table for explaining an example of data elements of an entry of a text karaoke effect attribute of an object according to the embodiment of the present invention;

FIG. 34 is a table for explaining an example of data elements of a layer extension attribute of an object according to the embodiment of the present invention;

FIG. 35 is a table for explaining an example of data elements of an entry of a layer extension attribute of an object according to the embodiment of the present invention;

FIG. 36 is a table for explaining an example of data elements of object region data of a Vclick access unit (AU) according to the embodiment of the present invention;

FIG. 37 is a flowchart showing a normal playback start processing sequence (when Vclick data is stored in a server) according to the embodiment of the present invention;

FIG. 38 is a flowchart showing another normal playback start processing sequence (when Vclick data is stored in the server) according to the embodiment of the present invention;

FIG. 39 is a flowchart showing a normal playback end processing sequence (when Vclick data is stored in the server) according-to the embodiment of the present invention;

FIG. 40 is a flowchart showing a random access playback start processing sequence (when Vclick data is stored in the server) according to the embodiment of the present invention;

FIG. 41 is a flowchart showing another random access playback start processing sequence (when Vclick data is stored in the server) according to the embodiment of the present invention;

FIG. 42 is a flowchart showing a normal playback start processing sequence (when Vclick data is stored in a client) according to the embodiment of the present invention;

FIG. 43 is a flowchart showing a random access playback start processing sequence (when Vclick data is stored in the client) according to the embodiment of the present invention;

FIG. 44 is a flowchart showing a filtering operation of the client according to the embodiment of the present invention;

FIG. 45 is a flowchart (part 1) showing an access point search sequence in a Vclick stream using a Vclick access table according to the embodiment of the present invention;

FIG. 46 is a flowchart (part 2) showing an access point search sequence in a Vclick stream using a Vclick access table according to the embodiment of the present invention;

FIG. 47 is a view for explaining an example wherein a Vclick_AU effective time interval and active period do not match according to the embodiment of the present invention;

FIG. 48 is a view for explaining an example of the data structure of NULL_AU according to the embodiment of the present invention;

FIG. 49 is a view for explaining an example of the relationship between the Vclick_AU effective time interval and active period using NULL_AU according to the embodiment of the present invention;

FIG. 50 is a flowchart for explaining an example (part 1) of the processing sequence of a metadata manager when NULL_AU according to the embodiment of the present invention is used;

FIG. 51 is a flowchart for explaining an example (part 2) of the processing sequence of a metadata manager when NULL_AU according to the embodiment of the present invention is used;

FIG. 52 is a flowchart for explaining an example (part 3) of the processing sequence of a metadata manager when NULL_AU according to the embodiment of the present invention is used;

FIG. 53 is a view for explaining an example of the structure of an enhanced DVD-Video disc according to the embodiment of the present invention;

FIG. 54 is a view for explaining an example of the directory structure in the enhanced DVD-Video disc according to the embodiment of the present invention;

FIG. 55 is a flowchart for explaining a DVD playback preparation process according to the embodiment of the present invention;

FIG. 56 is a flowchart for explaining an object selection method according to the embodiment of the present invention;

FIG. 57 is a flowchart for explaining an object playback method according to the embodiment of the present invention;

FIG. 58 is a view for explaining an example (part 1) of the configuration of a search table according to the embodiment of the present invention;

FIG. 59 is a view for explaining an example (part 2) of the configuration of a search table according to the embodiment of the present invention;

FIG. 60 is a view for explaining an example (part 3) of the configuration of a search table according to the embodiment of the present invention;

FIG. 61 is a view for explaining an example (part 4) of the configuration of a search table according to the embodiment of the present invention;

FIG. 62 is a view for explaining an example (part 5) of the configuration of a search table according to the embodiment of the present invention;

FIG. 63 is a view for explaining an example of a case wherein the same data is repetitively used in different scenes when the search table according to the embodiment of the present invention is used;

FIG. 64 is a view for explaining a search method (selection search) according to the embodiment of the present invention; and

FIG. 65 is a view for explaining a search method (match search) according to the embodiment of the present invention.

### DETAILED DESCRIPTION OF THE INVENTION

Embodiments of the present invention will be described in detail hereinafter with reference to the accompanying drawings.

(Overview of Application)

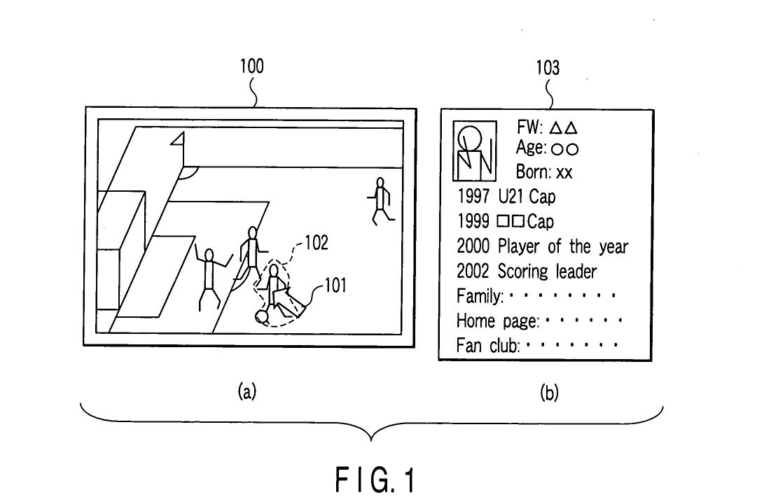

FIG. 1 shows a display example of an application (moving picture hypermedia) implemented by using object metadata according to the present invention together with a moving picture on the screen. In FIG. 1(a), reference numeral 100 denotes a moving picture playback window; and 101, a mouse cursor. Data of the moving picture which is played back on moving picture playback window 100 is recorded on a local moving picture data recording medium. Reference numeral 102 denotes a region of an object that appears in the moving picture. When the user moves the mouse cursor into the region of the object and selects it by, e.g., clicking a mouse button, a predetermined function is executed. For example, in FIG. 1(b), document (information associated with the clicked object) 103 on a local disc and/or a network is displayed. In addition, a function of jumping to another scene of the moving picture, a function of playing back another moving picture file, a function of changing a playback mode, and the like can be executed.

Data of region 102 of the object, action data of a client upon designation of this region by, e.g., clicking or the like, and the like will be referred to as object metadata or Vclick data together. The object metadata may be recorded on a local moving picture data recording medium (optical disc, hard disc, semiconductor memory, or the like) together with moving picture data, or may be stored on a server on the network and may be sent to the client via the network. How to implement this application will be described in detail hereinafter.

(System Model)

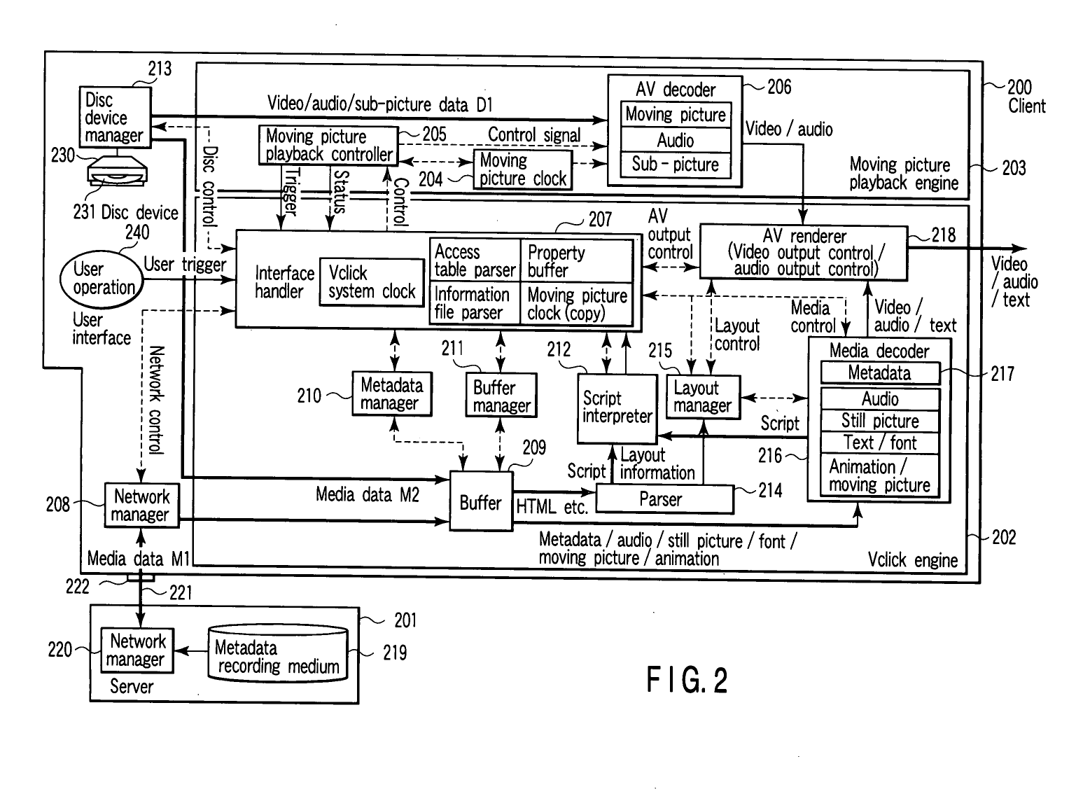

FIG. 2 is a schematic block diagram showing the arrangement of a streaming apparatus (network compatible disc player) according to the embodiment of the present invention. The functions of respective building components will be described below using FIG. 2.

Reference numeral 200 denotes a client; 201, a server; and 221, a network that connects client 200 and server 201. Client 200 comprises moving picture playback engine 203, Vclick engine 202, disc device 230, user interface 240, network manager 208, and disc device manager 213. Reference numerals 204 to 206 denote devices included in the moving picture playback engine; 207, 209 to 212, and 214 to 218, devices included in the Vclick engine; and 219 and 220, devices included in server 201. Client 200 can play back moving picture data, and can display a document described in a markup language (e.g., HTML), which are stored in disc device 230. Also, client 200 can display a document (e.g., HTML) on the network.

When metadata related to moving picture data stored in client 200 is stored in server 201, client 200 can execute a playback process using this metadata and the moving picture data in disc device 230. Server 201 sends media data Ml to client 200 via network 221 in response to a request from client 200. Client 200 processes the received media data in synchronism with playback of a moving picture to implement additional functions of hypermedia and the like (note that “synchronization” is not limited to a physically perfect match of timings but some timing error is allowed).

Moving picture playback engine 203 is used to play back moving picture data stored in disc device 230, and has devices 204, 205, and 206. Reference numeral 231 denotes a moving picture data recording medium (more specifically, a DVD, video CD, video tape, hard disc, semiconductor memory, or the like). Moving picture data recording medium 231 records digital and/or analog moving picture data. Metadata related to moving picture data may be recorded on moving picture data recording medium 231 together with the moving picture data. Reference numeral 205 denotes a moving picture playback controller, which can control playback of video/audio/sub-picture data D1 from moving picture data recording medium 231 in accordance with a “control” signal output from interface handler 207 of Vclick engine 202.

More specifically, moving picture playback controller 205 can output a “trigger” signal indicating the playback status of video/audio/sub-picture data D1 to interface handler 207 in accordance with a “control” signal which is transmitted upon generation of an arbitrary event (e.g., a menu call or title jump based on a user instruction) from interface handler 207 in a moving picture playback mode. In this case (at a timing simultaneously with output of the trigger signal or an appropriate timing before or after that timing), moving picture playback controller 205 can output a “status” signal indicating property information (e.g., an audio language, sub-picture caption language, playback operation, playback position, various kinds of time information, disc content, and the like set in the player) to interface handler 207. By exchanging these signals, a moving picture data read process can be started or stopped, and access to a desired location in moving picture data can be made.

AV decoder 206 has a function of decoding video data, audio data, and sub-picture data recorded on moving picture data recording medium 231, and outputting decoded video data (mixed data of the aforementioned video and sub-picture data) and audio data. Moving picture playback engine 203 can have the same functions as those of a playback engine of a normal DVD-Video player which is manufactured on the basis of the existing DVD-Video standard. That is, client 200 in FIG. 2 can play back video data, audio data, and the like with the MPEG2 program stream structure in the same manner as a normal DVD-Video player, thus allowing playback of existing DVD-Video discs (discs complying with the conventional DVD-Video standard) (to assure playback compatibility with existing DVD software).

Interface handler 207 makes interface control among modules such as moving picture playback engine 203, disc device manager 213, network manager 208, metadata manager 210, buffer manager 211, script interpreter 212, media decoder 216 (including metadata decoder 217), layout manager 215, AV renderer 218, and the like. Also, interface handler 207 receives an input event by a user operation (operation to an input device such as a mouse, touch panel, keyboard, or the like) from user interface 240 and transmits an event to an appropriate module.

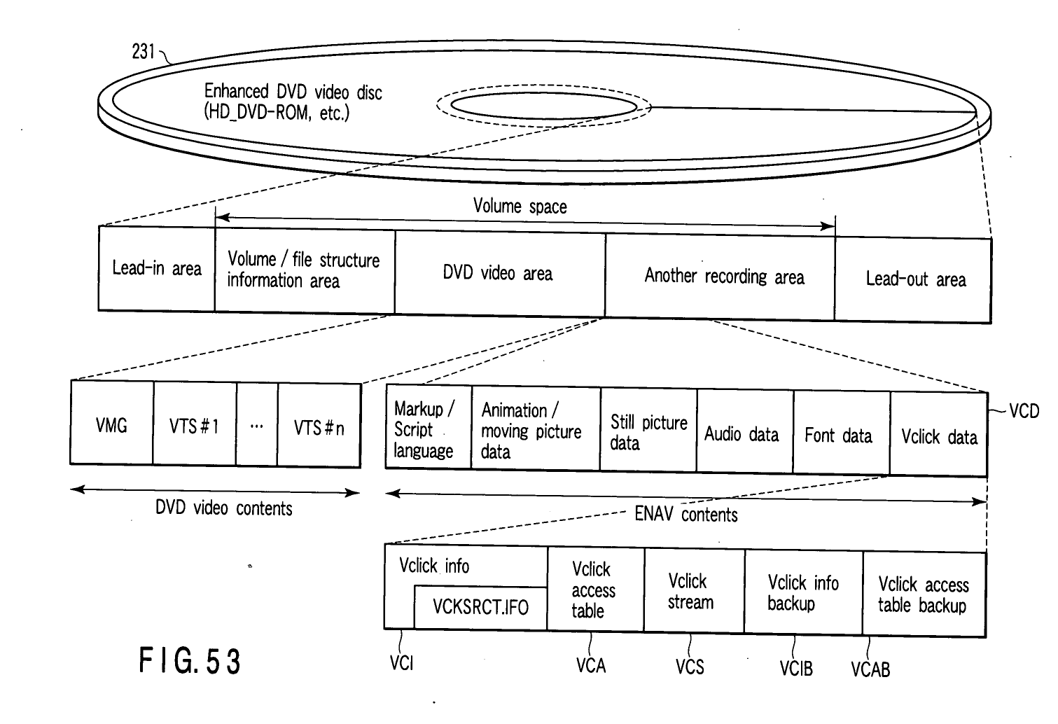

Interface handler 207 has an access table parser that parses a Vclick access table (corresponding to VCA which will be described later with reference to FIG. 53), an information file parser that parses a Vclick information file (corresponding to VCI which will be described later with reference to FIG. 53), a property buffer that records property information managed by the Vclick engine, a system clock of the Vclick engine, a moving picture clock as a copy of moving picture clock 204 in the moving picture playback engine, and the like.

Network manager 208 has a function of acquiring a document (e.g., HTML), still picture data, audio data, and the like into buffer 209 via the network, and controls the operation of Internet connection unit 222. When network manager 208 receives a connection/disconnection instruction to/from the network from interface handler 207 that has received a user operation or a request from metadata manager 210, it switches connection/disconnection of Internet connection unit 222. Upon establishing connection between server 201 and Internet connection unit 222 via the network, network manager 208 exchanges control data and media data (object metadata).

Data to be transmitted from client 200 to server 201 include a session open request, session close request, media data (object metadata) transmission request, status information (OK, error, etc.), and the like. Also, status information of the client may be exchanged. On the other hand, data to be transmitted from server 201 to client 200 include media data (object metadata) and status information (OK, error, etc.)

Disc device manager 213 has a function of acquiring a document (e.g., HTML), still picture data, audio data, and the like into buffer 209, and a function of transmitting video/audio/sub-picture data D1 to moving picture playback engine 203. Disc device manager 213 executes a data transmission process in accordance with an instruction from metadata manager 210.

Buffer 209 temporarily stores media data M1 which is sent from server 201 via the network (via the network manager). Moving picture data recording medium 231 records media data M2 in some cases. In such case, media data M2 is stored in buffer 209 via the disc device manager. Note that media data includes Vclick data (object metadata), a document (e.g., HTML), and still picture data, moving picture data, and the like attached to the document.

When media data M2 is recorded on moving picture data recording medium 231, it may be read out from moving picture data recording medium 231 and stored in buffer 209 in advance prior to the start of playback of video/audio/sub-picture data D1. This is for the following reason: since media data M2 and video/audio/sub-picture data D1 have different data recording locations on moving picture data recording medium 231, if normal playback is made, a disc seek or the like occurs and seamless playback cannot be guaranteed. The above process can avoid such problem.

As described above, when media data M1 downloaded from server 201 is stored in buffer 209 as in media data M2 recorded on moving picture data recording medium 231, video/audio/sub-picture data D1 and media data can be simultaneously read out and played back.

Note that the storage capacity of buffer 209 is limited. That is, the data size of media data M1 or M2 that can be stored in buffer 209 is limited. For this reason, unnecessary data may be erased under the control (buffer control) of metadata manager 210 and/or buffer manager 211.

Metadata manager 210 manages metadata stored in buffer 209, and transfers metadata having a corresponding time stamp from buffer 209 to media decoder 216 upon reception of an appropriate timing (“moving picture clock” signal) synchronized with playback of a moving picture from interface handler 207.

When metadata having a corresponding time stamp is not present in buffer 209, it need not be transferred to media decoder 216. Metadata manager 210 controls to load data for a size of the metadata output from buffer 209 or for an arbitrary size from server 201 or disc device 230 onto buffer 209. As a practical process, metadata manager 210 issues a metadata acquisition request for a designated size to network manager 208 or disc device manager 213 via interface handler 207. Network manager 208 or disc device manager 213 loads metadata for the designated size into buffer 209, and sends a metadata acquisition completion response to metadata manager 210 via interface handler 207.

Buffer manager 211 manages data (a document (e.g., HTML), still picture data and moving picture data appended to the document, and the like) other than metadata stored in buffer 209, and sends data other than metadata stored in buffer 209 to parser 214 and media decoder 216 upon reception of an appropriate timing (“moving picture clock” signal) synchronized with playback of a moving picture from interface handler 207. Buffer manager 211 may delete data that becomes unnecessary from buffer 209.

Parser 214 parses a document written in a markup language (e.g., HTML), and sends a script to script interpreter 212 and information associated with a layout to layout manager 215.

Script interpreter 212 interprets and executes a script input from parser 214. Upon executing the script, information of an event and property input from interface handler 207 can be used. When an object in a moving picture is designated by the user, a script is input from metadata decoder 217 to script interpreter 212.

AV renderer 218 has a function of controlling video/audio/text outputs. More specifically, AV renderer 218 controls, e.g., the video/text display positions and display sizes (often also including the display timing and display time together with them) and the level of audio (often also including the output timing and output time together with it) in accordance with a “layout control” signal output from layout manager 215, and executes pixel conversion of a video in accordance with the type of a designated monitor and/or the type of a video to be displayed. The video/audio/text outputs to be controlled are those from moving picture playback engine 203 and media decoder 216. Furthermore, AV renderer 218 has a function of controlling mixing or switching of video/audio data input from moving picture playback engine 203 and video/audio/text data input from the media decoder in accordance with an “AV output control” signal output from interface handler 207.

Layout manager 215 outputs a “layout control” signal to AV renderer 218. The “layout control” signal includes information associated with the sizes and positions of moving picture/still picture/text data to be output (often also including information associated with the display times such as display start/end timings and duration), and is used to designate AV renderer 218 about a layout used to display data. Layout manager 215 checks input information such as user's clicking or the like input from interface handler 207 to determine a designated object, and instructs metadata decoder 217 to extract an action command such as display of related information which is defined for the designated object. The extracted action command is sent to and executed by script interpreter 212.

Media decoder 216 (including the metadata decoder) decodes moving picture/still picture/text data. These decoded video data and text image data are transmitted from media decoder 216 to AV renderer 218. These data to be decoded are decoded in accordance with an instruction of a “media control” signal from interface handler 207 and in synchronism with a “timing” signal from interface handler 207.

Reference numeral 219 denotes a metadata recording medium of server 201 such as a hard disc, optical disc, semiconductor memory, magnetic tape, or the like, which records metadata to be transmitted to client 200. This metadata is related to moving picture data recorded on moving picture data recording medium 231. This metadata includes object metadata to be described later. Reference numeral 220 denotes a network manager of server 201, which exchanges data with client 200 via network 221.

(EDVD Data Structure and IFO File)

FIG. 53 shows an example of the data structure when an enhanced DVD-Video disc is used as moving picture data recording medium 231. A DVD-Video area of the enhanced DVD-Video disc stores DVD-Video content (having the MPEG-2 program stream structure) having the same data structure as that of the DVD-Video standard. Furthermore, another recording area of the enhanced DVD-Video disc stores enhanced navigation (to be abbreviated as ENAV hereinafter) content which allows various playback processes of video content. Note that the presence of “another recording area” is also recognized by the DVD-Video standard.

A basic data structure of the DVD-Video disc will be described below. The recording area of the DVD-Video disc includes a lead-in area, volume space, and lead-out area in turn from its inner periphery. The volume space includes a volume/file structure information area and DVD-Video area (DVD-Video zone), and can also have another recording area (DVD other zone) as an option.

The volume/file structure information area is assigned for the Universal Disk Format (UDF) bridge structure. The volume of the UDF bridge format is recognized according to ISO/IEC 13346 Part 2. A space that recognizes this volume includes successive sectors, and starts from the first logical sector of the volume space in FIG. 53. First 16 logical sectors are reserved for system use specified by ISO 9660. In order to assure compatibility to the conventional DVD-Video standard, the volume/file structure information area with such content is required.

The DVD-Video area records management information called video manager VMG and one or more video content items called video title sets VTS (VTS#1 to VTS#n). The VMG is management information for all VTSs present in the DVD-Video area, and includes control data VMGI, VMG menu data VMGM_VOBS (option), and VMG backup data. Each VTS includes control data VTSI of that VTS, VTS menu data VTSM_VOBS (option), data VTSTT_VOBS of the contents (movie or the like) of that VTS (title), and VTSI backup data. To assure compatibility to the conventional DVD-Video standard, the DVD-Video area with such content is also required.

A playback select menu or the like of respective titles (VTS#1 to VTS#n) is given in advance by a provider (the producer of a DVD-Video disc) using the VMG, and a playback chapter select menu, the playback order of recorded content (cells), and the like in a specific title (e.g., VTS#1) are given in advance by the provider using the VTSI. Therefore, the viewer of the disc (the user of the DVD-Video player) can enjoy the recorded content of that disc in accordance with menus of the VMG/VTSI prepared in advance by the provider and playback control information (program chain information PGCI) in the VTSI. However, with the DVD-Video standard, the viewer (user) cannot play back the content (movie or music) of each VTS by a method different from the VMG/VTSI prepared by the provider.

The enhanced DVD-Video disc shown in FIG. 53 is prepared for a scheme that allows the user to play back the content (movie or music) of each VTS by a method different from the VMG/VTSI prepared by the provider, and to play back while adding content different from the VMG/VTSI prepared by the provider. ENAV content included in this disc cannot be accessed by a DVD-Video player which is manufactured on the basis of the conventional DVD-Video standard (even if the ENAV contents can be accessed, their content cannot be used). However, a DVD-Video player according to the embodiment of the present invention (for example, client 200 which equips Vclick engine 202 in FIG. 2) can access the ENAV content, and can use their playback content.

The ENAV content includes data such as audio data, still picture data, font/text data, moving picture data, animation data, Vclick data, and the like, and also an ENAV document (described in a markup/script language) as information for controlling playback of these data. This playback control information describes, using a markup language or script language, playback methods (display method, playback order, playback switch sequence, selection of data to be played back, and the like) of the ENAV content (including audio, still picture, font/text, moving picture, animation, Vclick, and the like) and/or the DVD-Video content. For example, markup languages such as Hypertext Markup Language (HTML), Extensible Hypertext Markup Language (XHTML), Synchronized Multimedia Integration Language (SMIL), and the like, script languages such as European Computer Manufacturers Association (ECMA) Script, JavaScript®, and the like, and so forth, may be used in combination.

Since the content of the enhanced DVD-Video disc in FIG. 53 except for other recording areas complies with the DVD-Video standard, video content recorded on the DVD-Video area can be played back using an already prevalent DVD-Video player (i.e., this disc is compatible to the conventional DVD-Video disc). The ENAV content recorded on other recording areas cannot be played back (or used) by the conventional DVD-Video player but can be played back and used by a DVD-Video player according to the embodiment of the present invention. Therefore, when the ENAV content is played back using the DVD-Video player according to the embodiment of the present invention, the user can enjoy not only the content of the VMG/VTSI prepared in advance by the provider but also a variety of video playback features.

Especially, as shown in FIG. 53, the ENAV content includes Vclick data VCD, which includes Vclick information file (Vclick Info) VCI, Vclick access table VCA, Vclick stream VCS, Vclick information file backup (Vclick Info backup) VCIB, and Vclick access table backup VCAB.

Vclick information file VCI is data indicating a portion of DVD-Video content where Vclick stream VCS (to be described below) is appended (e.g., to the entire title, the entire chapter, a program chain, program, or cell as a part thereof, or the like of the DVD-Video content). Vclick access table VCA is assured for each Vclick stream VCS (to be described below), and is used to access Vclick stream VCS. Vclick stream VCS includes data such as location information of an object in a moving picture, an action description to be made upon clicking the object, and the like. Vclick information file backup VCIB is a backup of the aforementioned Vclick information file VCI, and always has the same content as Vclick information file VCI. Vclick access table backup VCAB is a backup of Vclick access table VCA, and always has the same content as Vclick access table VCA.

Note that Vclick information file VCI can store a “search table (VCKSRCT.IFO) of Vclick data” (to be described later) in the example of FIG. 53.

In the example of FIG. 53, Vclick data VCD is recorded on the enhanced DVD-Video disc. However, as described above, Vclick data VCD is stored in server 201 on the network in some cases. That is, Vclick data VCD (including the Vclick data search table) can be prepared inside/outside the disc. When Vclick data VCD is prepared outside the disc, playback using Vclick data VCD can be made even in content playback of an old type disc (a disc sold in the past or the like) that does not record any Vclick data VCD or in playback of content that records TV broadcasting (when Vclick data VCD are created in correspondence with these contents).

Furthermore, when the user creates an original disc using a video recordable medium (e.g., a DVD-R disc, DVD-RW disc, DVD-RAM disc, hard disc or the like) and a video recorder (e.g., a DVD-VR recorder, DVD-SR recorder, HD-DVD recorder, HDD recorder, or the like), if he or she records ENAV content including Vclick data VCD or prepares Vclick data VCD on a data storage of a personal computer other than this disc and connects this personal computer and recorder, he or she can enjoy metadata playback in the same manner as in the DVD-ROM video+the ENAV player in FIG. 2.

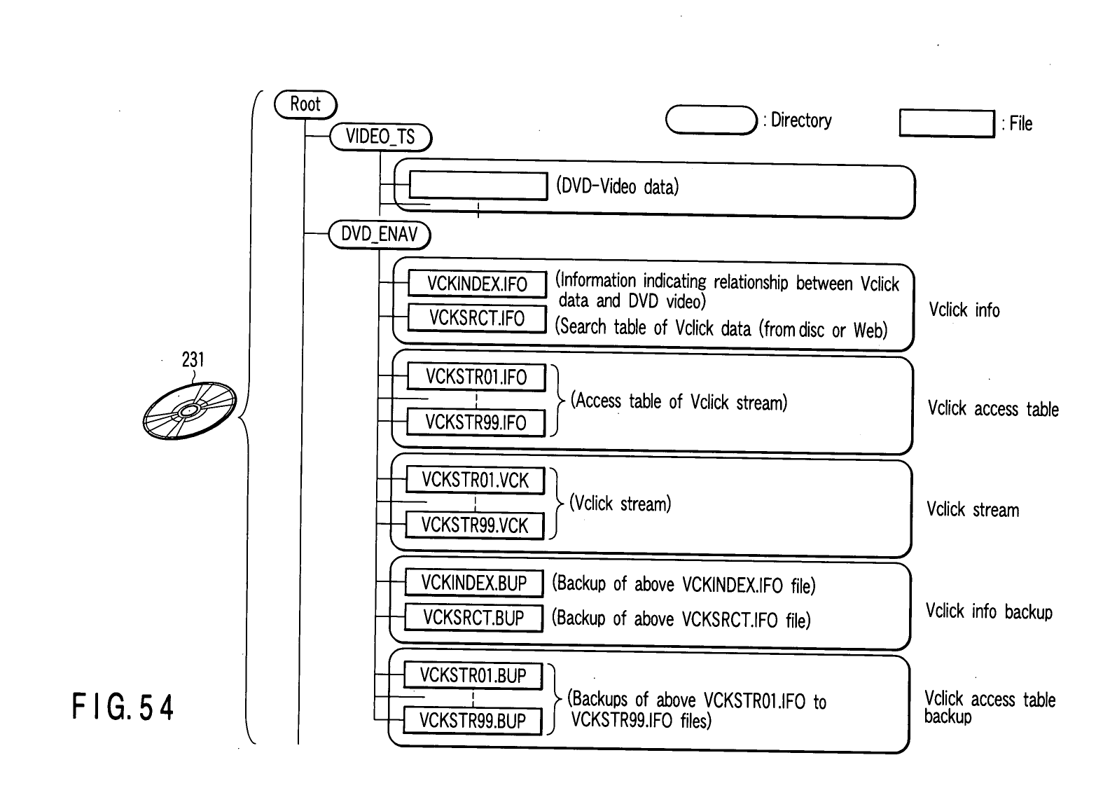

FIG. 54 shows an example of files which form the aforementioned Vclick information file VCI, Vclick access table VCA, Vclick stream VCS, Vclick information file backup VCIB, and Vclick access table backup VCAB. A file (VCKINDEX.IFO) that forms Vclick information file VCI is described in, e.g., Extensible Markup Language (XML), and describes Vclick streams VCS and the location information (VTS numbers, title numbers, PGC numbers, and the like) of the DVD-Video content where Vclick streams VCS are appended. The Vclick data search table (VCKSRCT.IFO) is described in, e.g., XML, and can take correspondence between Vclick objects and DVD-Video content so as to implement a quick search process. Vclick access table VCA is made up of one or more files (VCKSTR01.IFO to VCKSTR99.IFO or arbitrary file names), and one access table VCA file corresponds to one Vclick stream VCS.

A Vclick stream file describes the relationship between location information (a relative byte size from the head of the file) of each Vclick stream VCS and time information (a time stamp of a corresponding moving picture or relative time information from the head of the file), and allows to search for a playback start position corresponding to a given time.

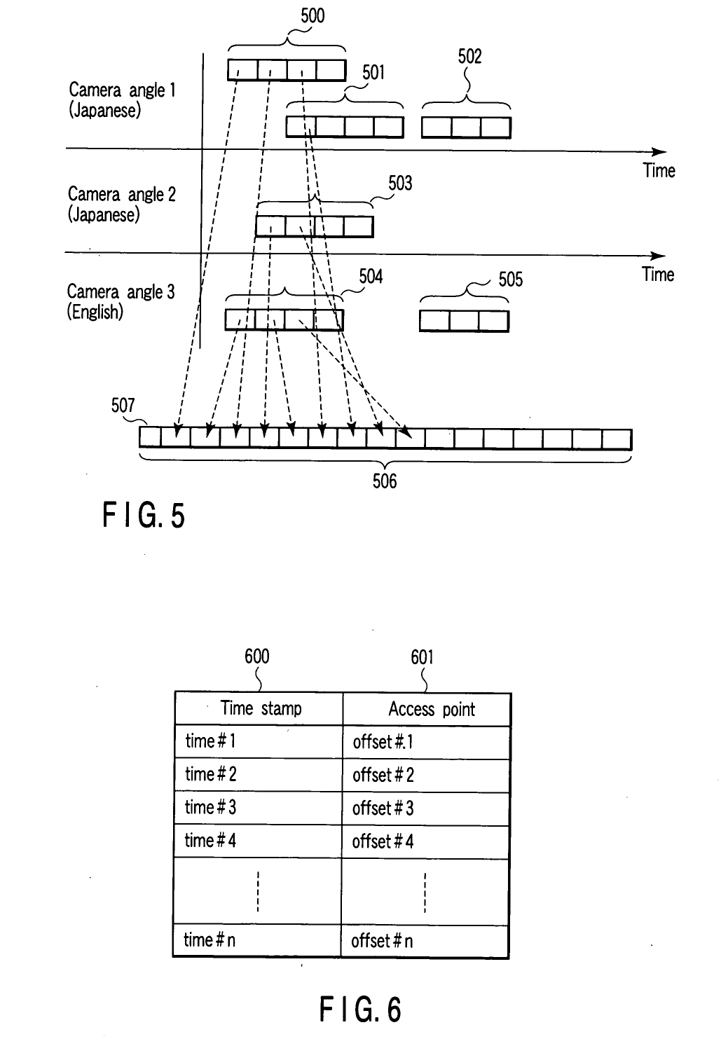

Vclick stream VCS includes one or more files (VCKSTR01.VCK to VCKSTR99.VCK or arbitrary file names), and can be played back together with the appended DVD-Video content with reference to the description of the aforementioned Vclick information file VCI. If there are a plurality of attributes (e.g., English Vclick data VCD, Japanese Vclick data VCD, and the like), different Vclick streams VCS (i.e., different files) may be formed in correspondence with different attributes. Alternatively, respective attributes may be multiplexed to form one Vclick stream VCS (i.e., one file) (for example, see FIG. 5).

In case of the former configuration (a plurality of Vclick streams VCS are formed in correspondence with different attributes), the occupied size of the buffer (e.g., 209 in the example of FIG. 2) upon temporarily storing Vclick data in the playback apparatus (player) can be reduced. In case of the latter configuration (one Vclick stream VCS is formed to include different attributes; the example shown in FIG. 5 or the like), one file can be kept played back without switching files upon switching attributes, thus assuring high switching speed.

Note that each Vclick stream VCS and Vclick access table VCA can be associated using, e.g., their file names. In the aforementioned example, one Vclick access table VCA (VCKSTRXX.IFO; XX=01 to 99) is assigned to one Vclick stream VCS (VCKSTRXX.VCK; XX=01 to 99). Hence, by adopting the same file name except for extensions, association between each Vclick stream VCS and Vclick access table VCA can be identified.

In addition, Vclick information file VCI describes association between each Vclick stream VCS and Vclick access table VCA (more specifically, the VCI parallelly describes descriptions of VCS and those of VCA), thereby identifying association between each Vclick stream VCS and Vclick access table VCA.

Vclick information file backup VCIB is formed of a VCKINDEX.BUP file and VCKSRCT.BUP file, and has the same contents as the aforementioned Vclick information file VCI (VCKINDEX.IFO) and Vclick data search table (VCKSRCT.IFO). If VCKINDEX.IFO and VCKSRCT.IFO cannot be loaded for some reason (due to scratches, smudges, and the like on the disc), desired procedures can be made by loading these VCKINDEX.BUP and VCKSRCT.BUP instead. Vclick access table backup VCAB is formed of VCKSTR01.BUP to VCKSTR99.BUP files, which have the same contents as the aforementioned Vclick access tables VCA (VCKSTR01.IFO to VCKSTR99.IFO). One Vclick access table backup VCAB (VCKSTRXX.BUP; XX=01 to 99) is assigned to one Vclick access table VCA (VCKSTRXX.IFO; XX=01 to 99), and the same file name is adopted except for extensions, thus identifying association between each Vclick access table VCA and Vclick access table backup VCAB. If VCKSTRXX.IFO cannot be loaded for some reason (due to scratches, smudges, and the like on the disc), desired procedures can be made by loading this VCKSTRXX.BUP instead.

(Overview of Data Structure and Access Table)

Vclick stream VCS includes data associated with regions of objects (e.g., persons, articles, and the like) that appear in the moving picture recorded on moving picture data recording medium 231, display methods of the objects in client 200, and data of actions to be taken by these objects when the user designates them. An overview of the structure of Vclick data and its elements will be explained below.

Object region data as data associated with a region of an object (e.g., a person, article, or the like) that appears in the moving picture will be explained first.

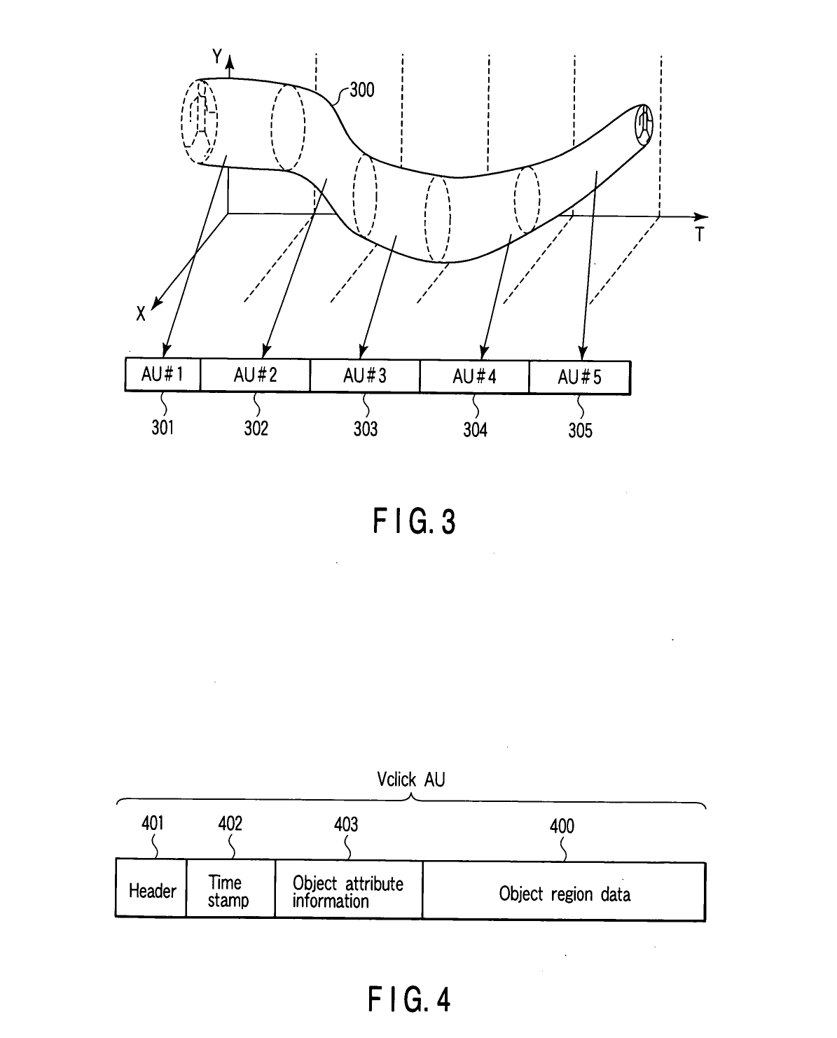

FIG. 3 is a view for explaining the structure of object region data. Reference numeral 300 denotes a locus, which is formed by a region of one object, and is expressed on a three-dimensional (3D) coordinate system of X (the horizontal coordinate value of a video picture), Y (the vertical coordinate value of the video picture), and T (the time of the video picture). An object region is converted into object region data for each predetermined time range (e.g., between 0.5 sec to 1.0 sec, between 2 sec to 5 sec, or the like). In FIG. 3, one object region 300 is converted into five object region data 301 to 305, which are stored in independent Vclick access units (AU: to be described later). As a conversion method at this time, for example, MPEG-4 shape encoding, an MPEG-7 spatio-temporal locator, or the like can be used. Since the MPEG-4 shape encoding and MPEG-7 spatio-temporal locator are schemes for reducing the data size by exploiting temporal correlation among object regions, they suffer problems: data cannot be decoded halfway, and if data at a given time is omitted, data at neighboring times cannot be decoded. Since the region of the object that continuously appears in the moving picture for a long time, as shown in FIG. 3, is converted into data by dividing it in the time direction, easy random access is allowed, and the influence of omission of partial data can be reduced. Each Vclick_AU is effective in only a specific time interval in a moving picture. A time interval in which a Vclick_AU is effective is called a lifetime of the Vclick_AU.

FIG. 4 shows the structure of one unit (Vclick_AU), which can be accessed independently, in Vclick stream VCS used in the embodiment of the present invention. Reference numeral 400 denotes object region data. As has been explained using FIG. 3, the locus of one object region in a given time interval is converted into data. The time interval in which the object region is described is called an active time of that Vclick_AU. Normally, the active time of a Vclick_AU is equal to the lifetime of that Vclick_AU. However, the active time of a Vclick_AU can be set as a part of the lifetime of that Vclick_AU.

Reference numeral 401 denotes a header of the Vclick_AU. Header 401 includes an ID used to identify the Vclick_AU, and data used to specify the data size of that AU. Reference numeral 402 denotes a time stamp which indicates that of the start of the lifetime of this Vclick_AU. Since the active time and lifetime of Vclick_AU are normally equal to each other, the time stamp also indicates a time of the moving picture corresponding to the object region described in object region data 400. As shown in FIG. 3, since the object region has a certain time range, time stamp 402 normally describes the time of the head of the object region. Of course, the time stamp may describe the time interval or the time of the end of the object region described in the object region data. Reference numeral 403 denotes object attribute information, which includes, e.g., the name of an object, an action description upon designation of the object, a display attribute of the object, and the like. These data in the Vclick_AU will be described in detail later. The server (201 in FIG. 2 or the like) preferably records Vclick_AUs in the order of time stamps so as to facilitate transmission.

FIG. 5 is a view for explaining the method of generating Vclick stream VCS by arranging a plurality of AUs in the order of time stamps. In FIG. 5, assume that there are two camera angles, i.e., camera angles 1 and 2, and a moving picture to be displayed is switched when the camera angle is switched at the client. Also, assume that there are two selectable language modes: English and Japanese, and different Vclick data are prepared in correspondence with these languages.

Referring to FIG. 5, Vclick_AUs for camera angle 1 and Japanese are 500, 501, and 502, and that for camera angle 2 and Japanese is 503. Also, Vclick_AUs for English are 504 and 505. Each of AUs 500 to 505 is data corresponding to one object in the moving picture. That is, as has been explained above using FIGS. 3 and 4, metadata associated with one object is made up of a plurality of Vclick_AUs (in FIG. 5, one rectangle represents one AU). The abscissa of FIG. 5 corresponds to time in the moving picture, and AUs 500 to 505 are plotted in correspondence with the times of appearance of the objects.

Temporal divisions of respective Vclick_AUs may be arbitrarily determined. However, when the divisions of Vclick_AUs are aligned to all objects, as shown in FIG. 5, data management becomes easy. Reference numeral 506 denotes Vclick stream VCS formed of these Vclick_AUs (500 to 505). Vclick stream VCS is formed by arranging Vclick_AUs in the order of time stamps after header 507.

Since the selected camera angle is more likely to be switched by the user during viewing, Vclick stream VCS is preferably prepared by multiplexing Vclick_AUs of different camera angles in this way. This is because quick display switching is allowed at the client 200 side. For example, when Vclick data is stored in server 201, Vclick stream VCS including Vclick_AUs of a plurality of camera angles is transmitted intact to client 200. In this way, since a Vclick_AU corresponding to a currently viewed camera angle always arrives the client, a camera angle can be switched instantaneously. Of course, setting information of client 200 may be sent to server 201, and only a required Vclick_AU may be selectively transmitted from Vclick stream VCS. In this case, since the client must communicate with the server (201), the process is delayed slightly (although this process delay problem can be solved if high-speed means such as an optical fiber or the like is used in communication).

On the other hand, since attributes such as a moving picture title, PGC of DVD-Video, the aspect ratio of the moving picture, viewing region, and the like are not so frequently changed, they are preferably prepared as independent Vclick streams VCS so as to lighten the process of client 200 and to reduce the load on the network. Vclick stream VCS to be selected of a plurality of Vclick streams VCS can be determined with reference to Vclick information file VCI, as has already been described above.

Another Vclick_AU selection method will be described below. A case will be examined below wherein client 200 downloads Vclick stream (VCS) 506 from server 201, and uses only required access units (AUs) on the client 200 side. In this case, IDs used to identify required Vclick_AUs may be assigned to respective AUs. Such an ID is called a filter ID.

The conditions of the required access units (AUs) are described in, e.g., Vclick information file VCI as follows:

<pgc num=“7”>
//audio/definition of Vclick stream VCS by subpicture
stream and angle

<object data=“file://dvdrom:/dvd_enav/vclick1.vck”

audio=“1” subpic=“1” angle=“1”/>

<object data=“file://dvdrom:/dvd_enav/vclick1.vck”

audio=“3” subpic=“2” angle=“1”/>
</pgc>

In this case, two different filtering conditions are described for one Vclick stream VCS. This indicates that two different Vclick_AUs having different attributes can be selected from single Vclick stream VCS in accordance with the settings of system parameters at the client.

Note that Vclick information file VCI may be present on the moving picture data recording medium (e.g., the enhanced DVD-Video disc in FIG. 53) or may be downloaded from server 201 to client 200 via the network. Vclick information file VCI is normally supplied from the same site as that of Vclick streams VCS such as the moving picture data recording medium (enhanced DVD-Video disc), server (201), or the like.

If access units (AUs) have no filter IDs, metadata manager 210 identifies the required Vclick_AUs by checking the time stamps, attributes, and the like of AUs so as to select AUs that match the given conditions.

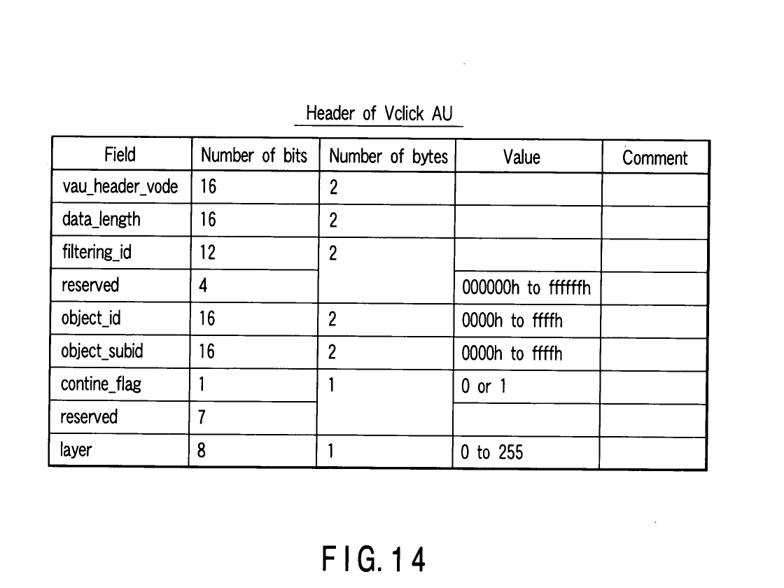

An example using the filter IDs will be explained according to the above description. In the above conditions, “audio” represents an audio stream number, which is expressed by a 4-bit numerical value. Likewise, 4-bit numerical values are assigned to sub-picture number “subpic” and angle number “angle”. In this way, the states of three parameters can be expressed by a 12-bit numerical value. For example, three parameters audio=“3”, subpic=“2”, and angle=“1” can be expressed by 0x321 (hex). This value is used as a filter ID. That is, each Vclick_AU has a 12-bit filter ID in a Vclick_AU header (see filtering_id in FIG. 14). This method defines a filter ID by assigning numerical values to independent parameter values used to identify each AU, and combining these values. Note that the filter ID may be described in a field other than the Vclick_AU header.

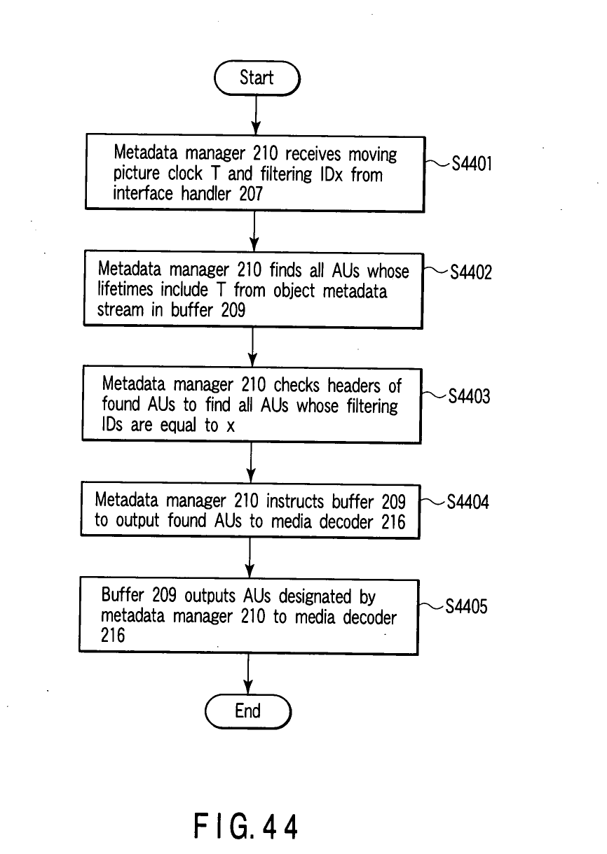

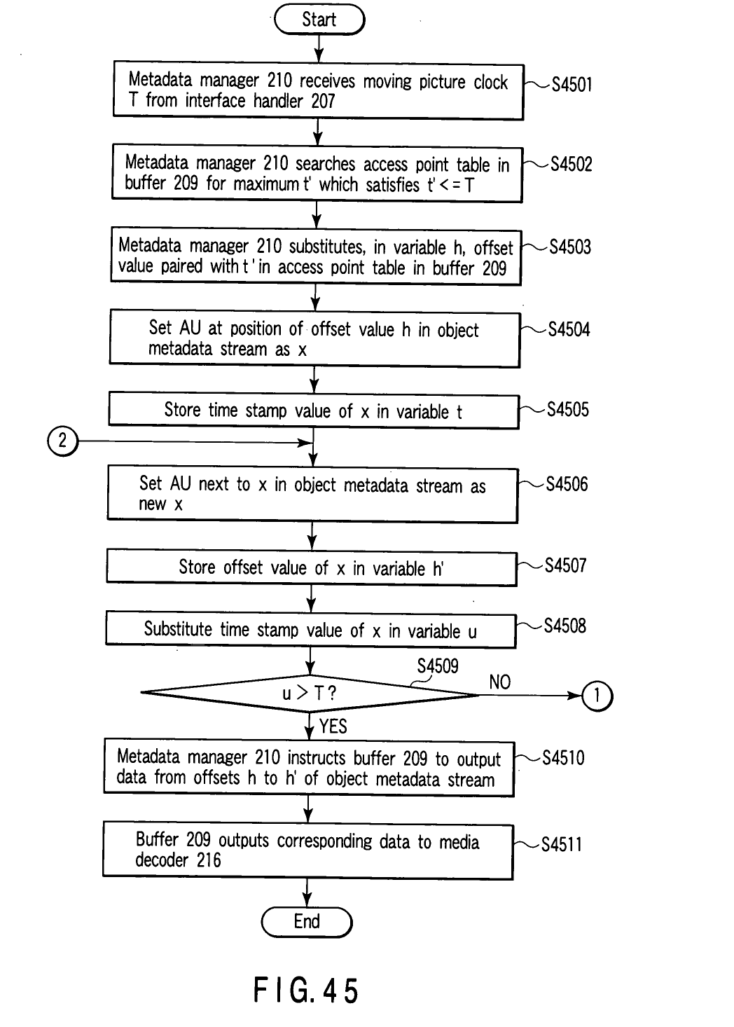

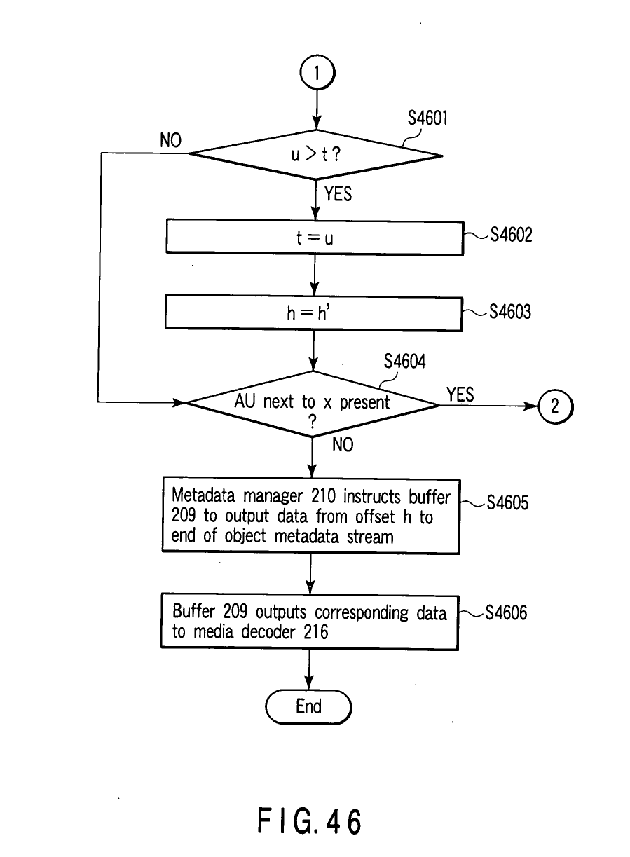

FIG. 44 shows the filtering operation of client 200. Metadata manager 210 receives moving picture clock value T and filter ID x from interface handler 207 (step S4401). Metadata manager 210 finds out all Vclick_AUs whose lifetimes include moving picture clock value T from Vclick stream VCS stored in buffer 209 (step S4402). In order to find out such AUs, procedures shown in FIGS. 45 and 46 can be used using Vclick access table VCA. Metadata manager 210 checks the Vclick_AU headers, and sends only AUs with the same filter ID as x to media decoder 216 (steps S4403 to S4405).

Vclick_AUs which are sent from buffer 209 to metadata decoder 217 with the aforementioned procedures have the following properties:

i) All these AUs have the same lifetime, which includes moving picture clock T.

ii) All these AUs have the same filter ID x.

iii) AUs in the object metadata stream which satisfy the above conditions i) and ii) are not present except for these AUs.

Note that identifying and selecting a specific AU by a given filter ID is to also select a Vclick stream including the selected AU. On the other hand, the Vclick stream to be played back can also be selected with reference to the Vclick Info VCI file.

In the above description, each filter ID is defined by a combination of values assigned to parameters. Alternatively, the filter IDs may be directly designated in Vclick information file VCI. For example, the filter IDs are defined in the IFO file as follows:

<pgc num=“5”>
<param angle=“1”>

<object data=“file://dvdrom:/dvd_enav/vclick1.vck”

filter_id=“3”/>
</param>
<param angle=“3”>

<object data=“file://dvdrom:/dvd_enav/vclick2.vck”

filter_id=“4”/>
</param>
<param aspect=“16:9” display=“wide”>

<object data=“file://dvdrom:/dvd_enav/vclick1.vck”

filter_id=“2”/>
</param>
</pgc>

The above description indicates that Vclick streams VCS and filter ID values are determined by designating parameters. Selection of Vclick_AUs by the filter IDs and transfer of AUs from buffer 209 to media decoder 216 are done in the same procedures as in FIG. 44. Based on the designation of Vclick information file VCI, when the angle number of the player is “3”, only Vclick_AUs whose filter ID value is equal to “4” are sent from Vclick stream VCS stored in the file “vclick2.vck” in buffer 209 to media decoder 216.

When Vclick data is stored in server 201, and a moving picture is to be played back from its head, server 201 need only distribute Vclick stream VCS in turn from the head to the client. However, if a random access has been made, data must be distributed from the middle of Vclick stream VCS. At this time, in order to quickly access a desired position in Vclick stream VCS, Vclick access table VCA is required.

FIG. 6 shows an example of Vclick access table VCA. This table is prepared in advance, and is recorded in server 201. This table can also be stored in the same file as Vclick information file VCI. Reference numeral 600 denotes a time stamp sequence, which lists time stamps of the moving picture. Reference numeral 601 denotes an access point sequence, which lists offset values from the head of Vclick stream VCS in correspondence with the time stamps of the moving picture. If a value corresponding to the time stamp of the random access destination of the moving picture is not stored in Vclick access table VCA, an access point of a time stamp with a value close to that time stamp is referred to, and a transmission start location is sought while referring to time stamps in Vclick stream VCS near that access point. Alternatively, Vclick access table VCA is searched for a time stamp of a time before that of the random access destination of the moving picture, and Vclick stream VCS is transmitted from an access point corresponding to the time stamp.

Server 201 stores Vclick access table VCA and uses it for convenience to search for Vclick data to be transmitted in response to random access from the client. However, Vclick access table VCA stored in server 201 may be downloaded to client 200, which may search for Vclick stream VCS. Especially, when Vclick streams VCS are simultaneously downloaded from server 201 to client 200, Vclick access tables VCA are also simultaneously downloaded from server 201 to client 200.

On the other hand, a moving picture recording medium such as a DVD or the like which records Vclick streams VCS may be provided. In this case as well, it is effective for client 200 to use Vclick access table VCA so as to search for data to be used in response to random access of playback contents. In such case, Vclick access tables VCA are recorded on the moving picture recording medium as in Vclick streams VCS, and client 200 reads and uses Vclick access table VCA of interest from the moving picture recording medium onto its internal main memory or the like.

Random playback of Vclick streams VCS, which is produced upon random playback of a moving picture or the like, is processed by metadata decoder 217. In Vclick access table VCA shown in FIG. 6, time stamp “time” is time information which has a time stamp format of a moving picture recorded on the moving picture recording medium. For example, when the moving picture is compressed by MPEG-2 upon recording, “time” has an MPEG-2 presentation time stamp (PTS) format. Furthermore, when the moving picture has a navigation structure of titles, program chains, and the like as in DVD, parameters (title numbers TTN, video title set numbers VTS_TTN, title program chain numbers TT_PGCN, part-of-title numbers PTTN, and the like) that express them are included in the format of “time”.

Assume that some natural totally ordered relationship is defined for a set of time stamp values. For example, as for the PTS, a natural ordered relationship as a time can be introduced. As for time stamps including DVD parameters, the ordered relationship can be introduced according to a natural playback order of the DVD. Each Vclick stream VCS satisfies the following conditions:

i) Vclick_AUs in Vclick stream VCS are arranged in ascending order of time stamp.

At this time, the lifetime of each Vclick_AU is determined as follows: Let t be the time stamp value of a given AU. Time stamp values u of AUs after the given AU satisfy u>=t under the above condition. Let t′ be a minimum one of such “u”s, which satisfies u≠t. A period which has time t as the start time and time t′ as the end time is defined as the lifetime of the AU of interest. If there is no AU which has time stamp value u that satisfies u>t after the AU of interest, the end time of the lifetime of the AU of interest matches the end time of the moving picture.

The active time of each Vclick_AU corresponds to the time range of the object region described in the object region data included in that Vclick_AU, as has been defined above. Note that the following constraint associated with the active time for Vclick stream VCS is set:

ii) The active time of a Vclick_AU is included in the lifetime of that AU.

Vclick stream VCS which satisfies the above constraints i) and ii) has the following good properties:

First, high-speed random access of Vclick stream VCS can be made, as will be described later. Second, a buffer process upon playing back Vclick stream VCS can be simplified.

The buffer (209 in FIG. 2 or the like) stores Vclick stream VCS for respective Vclick_AUs, and erases AUs from those which have larger time stamp values. If there are no two assumptions above, a large buffer and complicated buffer management are required so as to hold effective AUs on the buffer. The following description will be given under the assumption that Vclick stream VCS satisfies the above two conditions i) and ii).

In Vclick access table VCA shown in FIG. 6, access point “offset” indicates a position on Vclick stream VCS. For example, Vclick stream VCS is a file, and “offset” indicates a file pointer value of that file. The relationship of access point “offset”, which forms a pair with time stamp “time”, is as follows:

i) A position indicated by “offset” is the head position of a given Vclick_AU.

ii) A time stamp value of that AU is equal to or smaller than the value of “time”.

iii) A time stamp value of an AU immediately before that AU is truly smaller than “time”.

In Vclick access table VCA, “time”s may be arranged at arbitrary intervals but need not be arranged at equal intervals. However, they may be arranged at equal intervals in consideration of convenience for a search process and the like.

FIGS. 45 and 46 show the practical search procedures using Vclick access table VCA. When Vclick stream VCS is downloaded in advance from server 201 to buffer 209, Vclick access table VCA is also downloaded from server 201 and is stored in buffer 209. When both Vclick stream VCS and Vclick access table VCA are stored in moving picture data recording medium 231, they are loaded from disc device 230 and are stored in buffer 209.

Upon reception of moving picture clock T from interface handler 207 (step S4501), metadata manager 210 searches “time” values of Vclick access table VCA stored in buffer 209 for maximum time t′ which satisfies t′<=T (step S4502). A high-speed search can be conducted using, e.g., binary search as a search algorithm. The “offset” value which forms a pair with the obtained time t′ in Vclick access table VCA is substituted in variable h (step S4503). Metadata manager 210 finds AUx which is located at the h-th byte position from the head of Vclick stream VCS stored in buffer 209 (step S4504), and substitutes the time stamp value of x in variable t (step S4505). According to the aforementioned conditions, since t is equal to or smaller than t′, t<=T.

Metadata manager 210 checks Vclick_AUs in Vclick stream VCS in turn from x and sets the next AU as new x (step S4506). The offset value of x is substituted in variable h′ (step S4507), and the time stamp value of x is substituted in variable u (step S4508). If u>T (YES in step S4509), metadata manager 210 instructs buffer 209 to send data from offsets h to h′ of Vclick stream VCS to media decoder 216 (steps S4510 and S4511). On the other hand, if u<=T (NO in step S4509) and u>T (YES in step S4601), the value of t is updated by u (i.e., t=u) (step S4602). Then, the value of variable h is updated by h′ (i.e., h=h′) (step S4603).

If the next AU is present on Vclick stream VCS (i.e., if x is not the last AU) (YES in step S4604), the next AU is set as new x to repeat the aforementioned procedures (the flow returns to step S4506 in FIG. 45). If x is the last Vclick_AU of Vclick stream VCS of interest (NO in step S4604), metadata manager 210 instructs buffer 209 to send data from the offset h to the end of Vclick stream VCS to media decoder 216 (steps S4605 and S4606).

With the aforementioned procedures, Vclick_AUs sent from buffer 209 to media decoder 216 apparently have the following properties:

i) All Vclick_AUs have the same lifetime. In addition, moving picture clock T is included in this lifetime.

ii) Vclick_AUs in Vclick stream VCS which satisfy the above condition i) are not present except for these AUs.

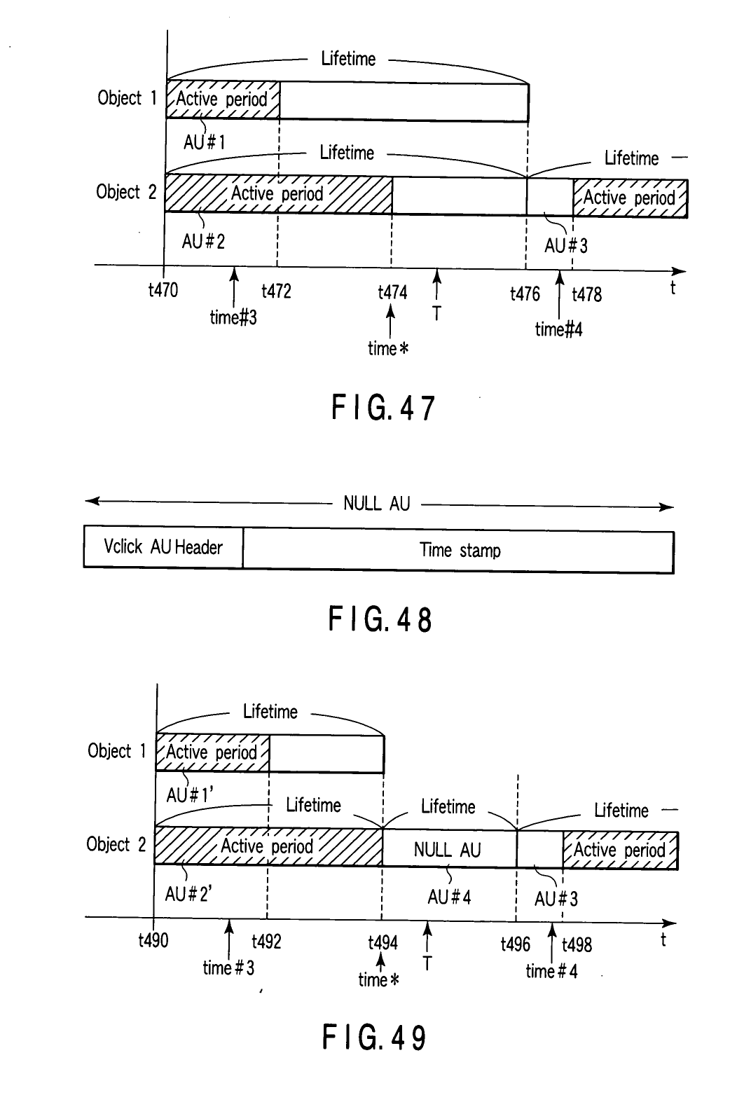

The lifetime of each Vclick_AU in Vclick stream VCS includes the active time of that AU, but they do not always match. In practice, a case shown in FIG. 47 is possible. The lifetimes of AU#1 and AU#2 which respectively describe objects 1 and 2 are up to the start time (t476) of the lifetime of AU#3. However, the active times of respective AUs do not match their lifetimes (t476≠t474≠t472 in the example of FIG. 47).

Vclick stream VCS in which AUs are arranged in the order of #1, #2, and #3 will be examined. Assume that moving picture clock T is designated in the example of FIG. 47. According to the procedures shown in FIGS. 45 and 46, AU#1 and AU#2 are sent from this Vclick stream VCS to media decoder 216. Since media decoder 216 can recognize the active times of the received Vclick_AUs, random access can be implemented by this process. However, in practice, since data transfer from buffer 209 and a decode process in media decoder 216 take place at time T (between t474 and t476, which is lifetime, but not active time) at which no object is present, the calculation efficiency of hardware at client 200 drops. This problem can be solved by introducing a special Vclick_AU called a NULL_AU.

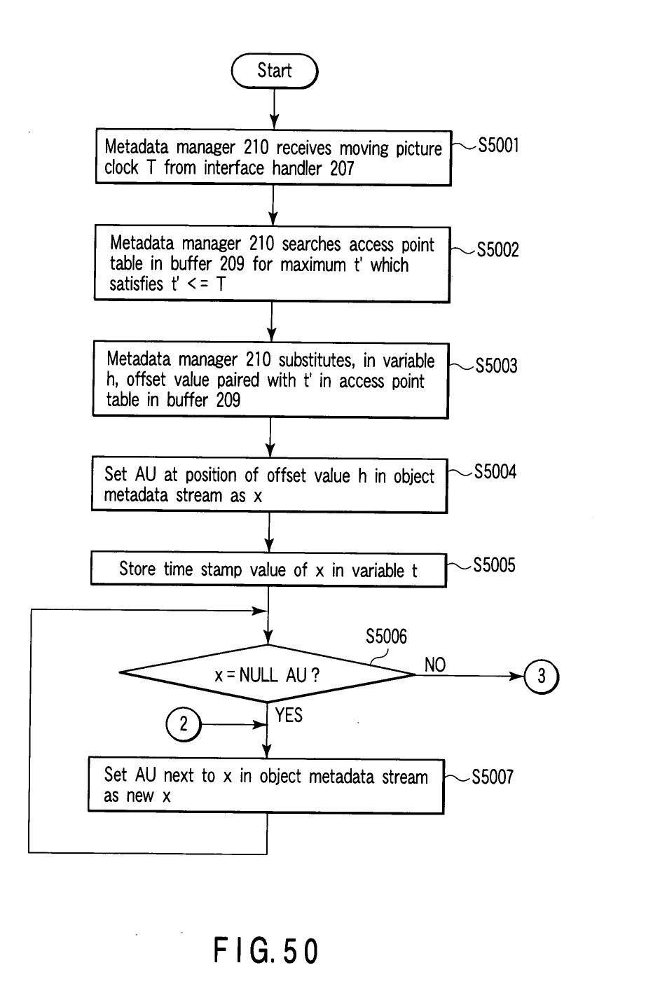

FIG. 48 shows the structure of the NULL_AU. The NULL_AU does not have any object region data unlike a normal Vclick_AU. Therefore, the NULL_AU has only a lifetime, but does not have any active time. The header of the NULL_AU includes a flag indicating that the AU of interest is the NULL_AU. The NULL_AU can be inserted within a time range (t494 to t496 in the example of FIG. 49) where no active time of an object (object 2 in the example of FIG. 49) is present in Vclick stream VCS.

When metadata manager 210 detects based on the flag (not shown) included in the header (“Vclick AU Header” in FIG. 48) that the AU of interest is “NULL_AU”, it does not output that NULL_AU to media decoder 216. When such NULL_AU is introduced, FIG. 47 changes like, for example, FIG. 49. AU#4 in FIG. 49 is a NULL_AU. In this case, in Vclick stream VCS, Vclick_AUs are arranged in the order of AU#1′, AU#2′, AU#4, and AU#3. FIGS. 50, 51, and 52 show the operation of metadata manager 210 corresponding to FIGS. 45 and 46 in association with Vclick stream VCS including a NULL_AU.

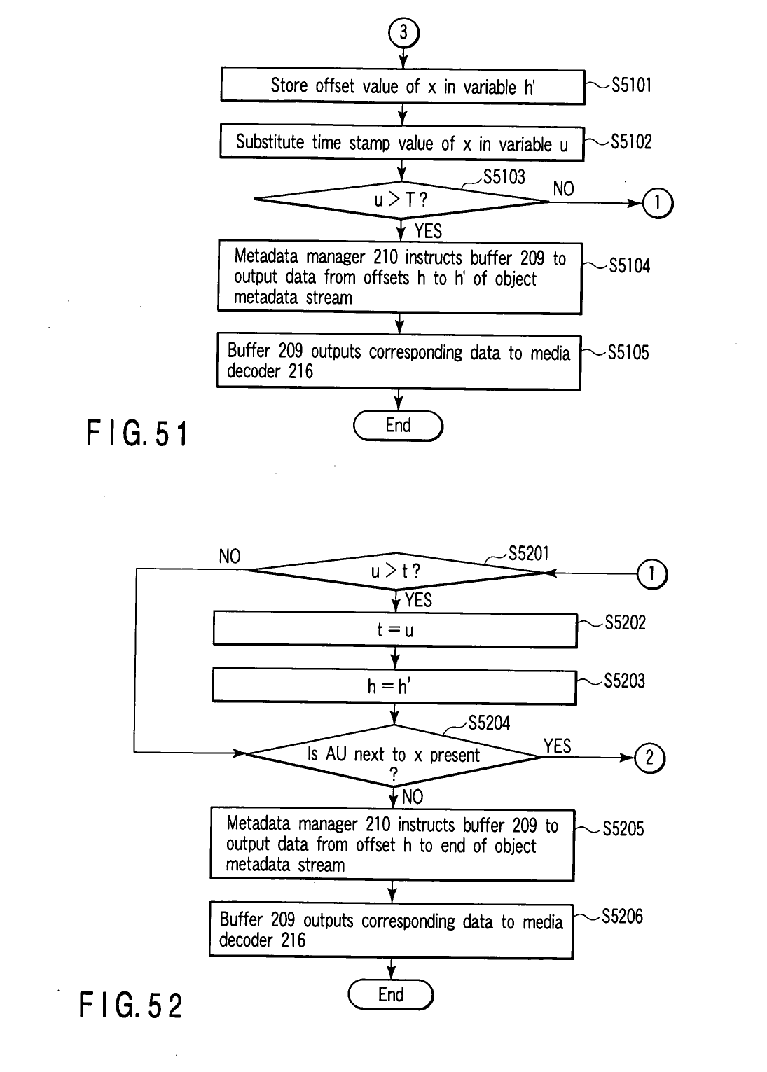

That is, metadata manager 210 receives moving picture clock T from interface handler 207 (step S5001), obtains maximum t′ which satisfies t′<=T (step S5002), and substitutes the “offset” value which forms a pair with t′ in variable h (step S5003). An access unit AU which is located at the position of offset value h in the object metadata stream is set as x (step S5004), and the time stamp value of x is stored in variable t (step S5005). If x is a NULL_AU (YES in step S5006), an AU next to x is set as new x (step S5007), and the flow returns to step S5006. If x is not a NULL_AU (NO in step S5006), the offset value of x is stored in variable h′ (step S5101). The subsequent processes (steps S5102 to S5105 in FIG. 51 and steps S5201 to S5206 in FIG. 52) are the same as those in steps S4508 to S4511 in FIG. 45 and steps S4601 to S4606 in FIG. 46.

(Search Table)

In order to cope with a case wherein the user wants to search all Vclick streams (or a plurality of Vclick stream groups) for specific Vclick data, the search table that allows the user to efficiently search for the target Vclick data is prepared. The information (VCKSRCT.IFO) of this table is stored in Vclick information VCI in disc 231 in the example of FIG. 53, and the file of this search table is allocated in directory DVD_ENAV, as exemplified in FIG. 54.

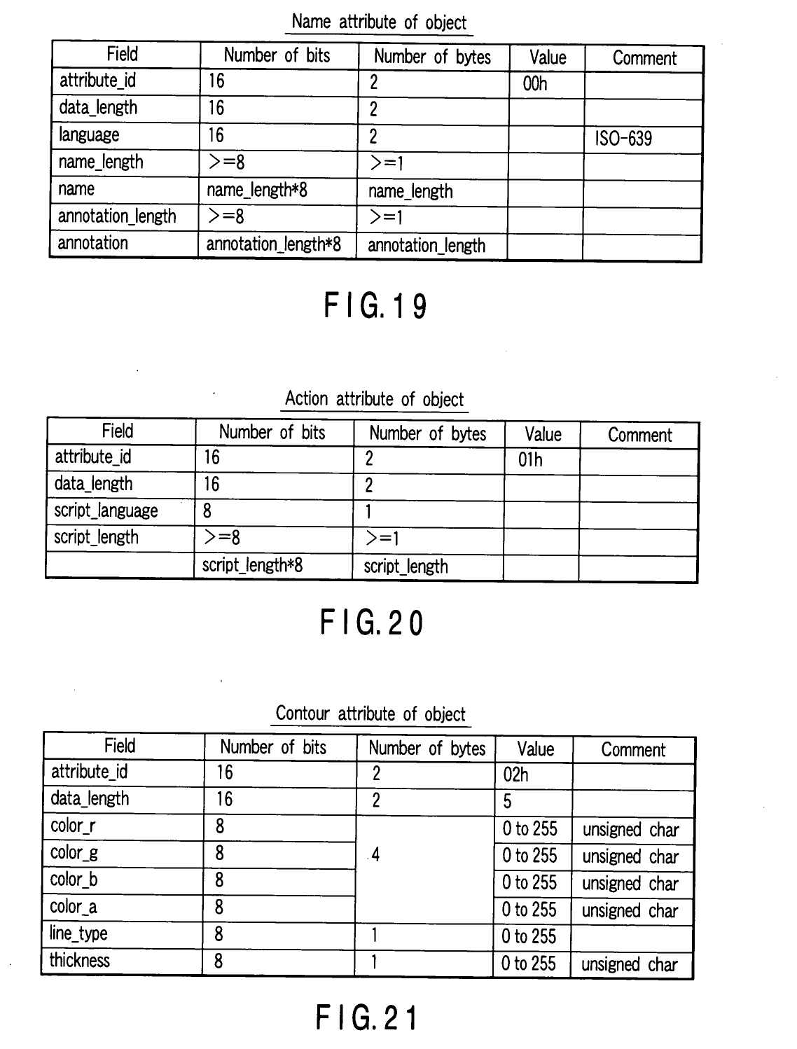

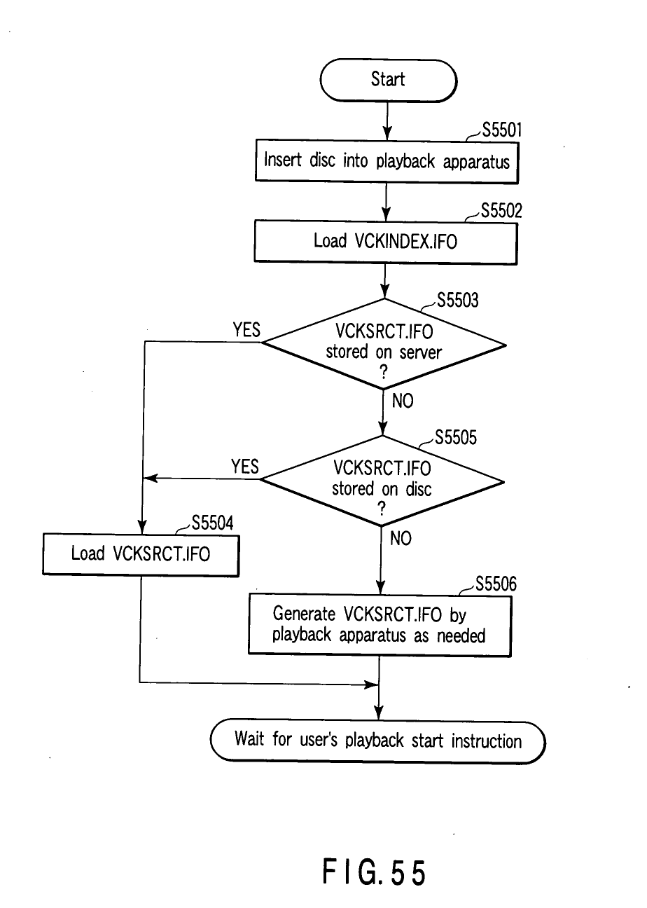

FIG. 55 is a flowchart for explaining a DVD playback preparation process according to the embodiment of the present invention. As shown in FIG. 55, the search table (VCKSRCT.IFO) is read after the disc is inserted into the playback apparatus (disc drive) (S5501) and VCKSRCT.IFO is loaded (S5502). This search table (VCKSRCT.IFO) can be recorded on the disc or server or in the playback apparatus. When the contents producer prepares this table for the sake of convenience of the search process, this table may be recorded on the disc. When the search table is to be updated after creation of the disc, a new search table may be created on the server to update the old one. Also, the firmware of the playback apparatus itself may create the search table on the basis of the Vclick IDs and annotations (character strings which represent annotations associated with objects described in Vclick_AUs: see FIG. 19).

More specifically, if the information (VCKSRCT.IFO) of the search table is stored on the server (YES in step S5503), the search table is loaded from the server (S5504); if it is stored not on the server but on the disc (NO in step S5503; YES in step S5505), the search table is loaded from the disc (S5504). If the information (VCKSRCT.IFO) of the search table is not stored on either the server or the disc (NO in step S5503; NO in step S5505), the playback apparatus waits for a playback start instruction from the user without any search table or automatically creates the information (VCKSRCT.IFO) of the search table (S5506).

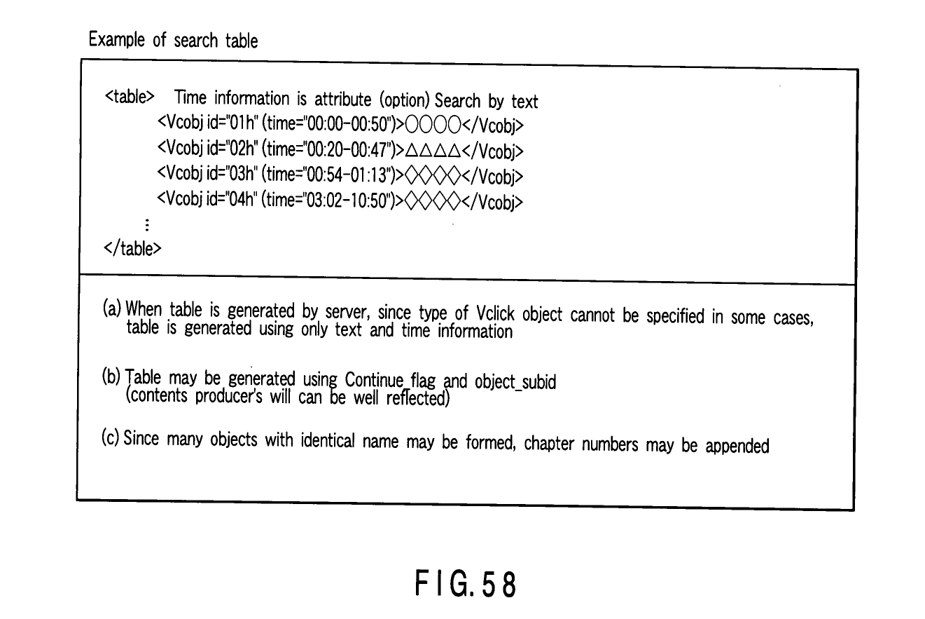

This automatic creation can be embodied by associating the related time and/or text to each of the IDs-of a plurality of Vclick objects prepared as a default with reference to VCKINDEX.IFO (information indicating the relationship between Vclick data and DVD-Video) shown in FIG. 54 (see (a) of FIG. 58).

Alternatively, the information (VCKSRCT.IFO) of the search table can be automatically created by utilizing “continue_flag”, “object_subid”, and the like shown in FIG. 14 (see (b) of FIG. 58).

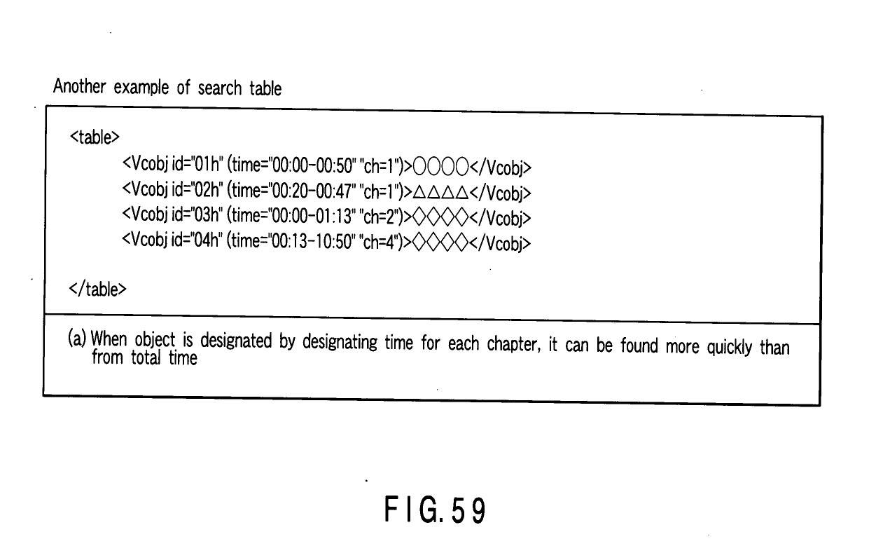

Alternatively, the information (VCKSRCT.IFO) of the search table can be automatically created by associating the designated times for respective chapters of video data recorded as the DVD-Video content to the IDs of a plurality of Vclick objects prepared as a default (see (c) of FIG. 58, FIG. 59, and the like).

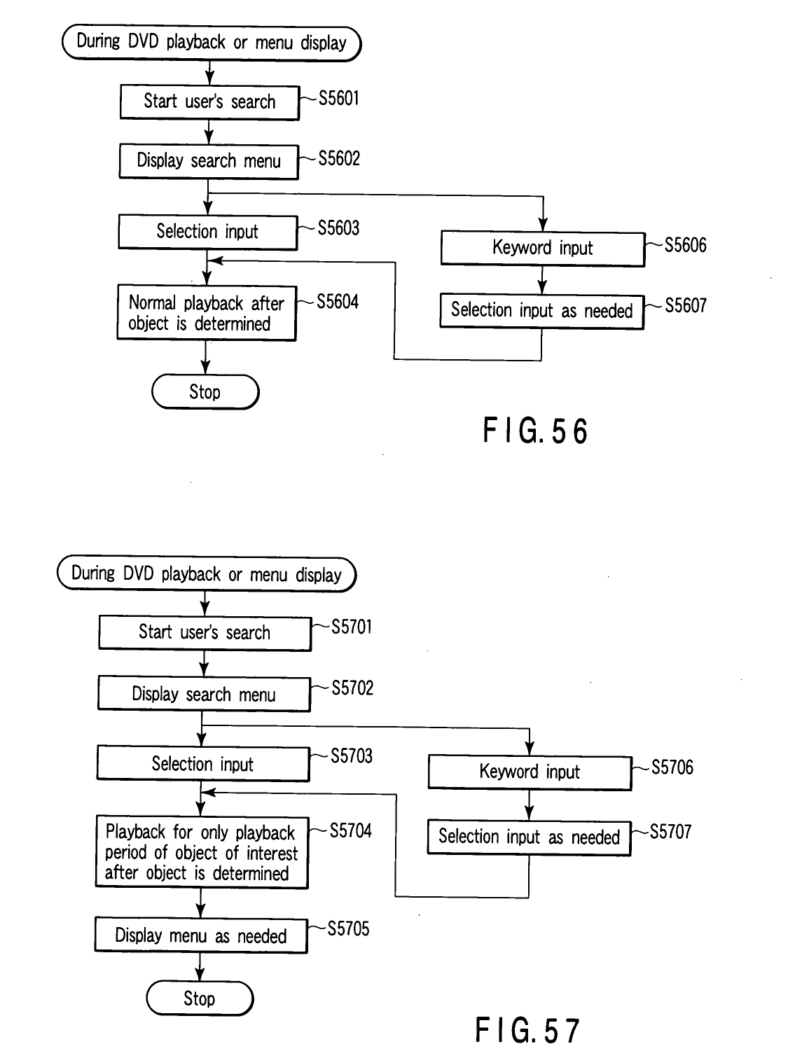

FIGS. 56 and 57 are flowcharts for explaining examples of the object selection method and playback method. A search is started by a user's operation during DVD playback including a menu (S5601 or S5701). If the user's search process is started using a remote controller or the like, a search menu is displayed (S5602 or S5702), and the user selects a match search using keywords (S5606 and S5607 or S5706 and S5707), or a selection search (S5603 or S5703).

FIG. 58 is a view for explaining an example (part 1) of the configuration of the search table according to the embodiment of the present invention. The user can conduct a text match search using text information (see “circle circle circle circle”, “rhombus rhombus rhombus rhombus”, and the like in FIG. 58) described in Vcobj tags, or a selection search. In the text match search, the user inputs search terms using an input device such as a remote controller, keyboard, mouse, or the like. Vclick data which match or are related to the terms are searched for, and the search results are displayed (notified) for the user by displaying corresponding thumbnails, jumping to corresponding positions, or the like.

In case of the selection search, the user can access data to be searched for by selecting in turn keywords displayed on the screen using an input device such as a remote controller, keyboard, mouse, or the like. By adopting this method, data to be searched for can be narrowed down. Also, the above two methods (selection search and match search) can be used in combination.

The information (VCKSRCT.IFO) of the search table is created using XML, as exemplified in FIG. 58, and is associated by Vcobj tags having the object IDs of target Vclick data as attributes. In order to access a target object more quickly, each Vcobj tag may have a playback start time of an object as attribute information.

FIG. 59 is a view for explaining an example (part 2) of the configuration of the search table according to the embodiment of the present invention. As exemplified in FIG. 59, in order to cope with a case wherein different Vclick data are designated for identical text information (Vcobj id=“03h” and Vcobj id=“04h”), a chapter number, display time, and the like (e.g., time=00:00-00:50” and “ch=1”) can be designated as attribute information.

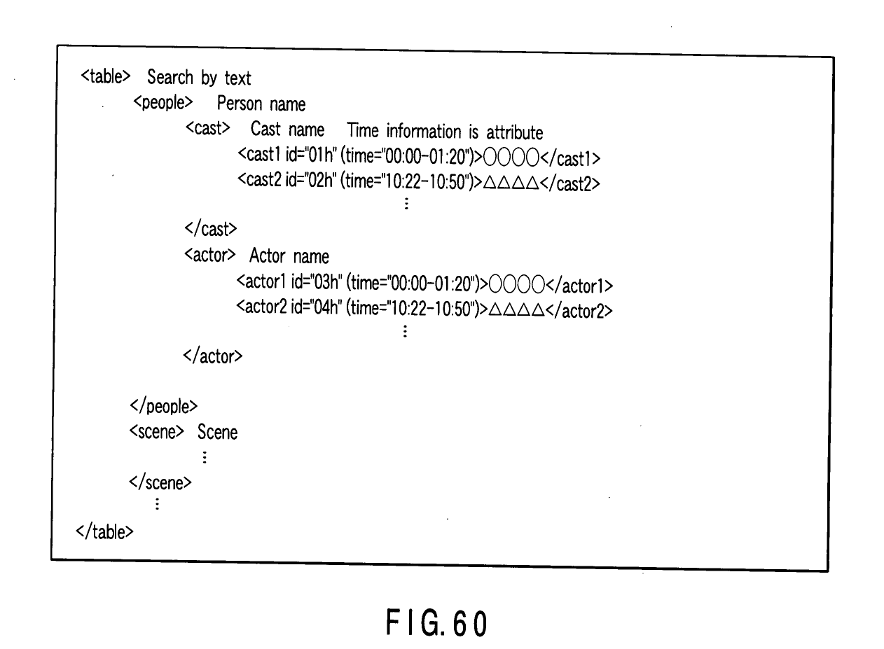

FIG. 60 is a view for explaining an example (part 3) of the configuration of the search table according to the embodiment of the present invention. In the example of FIG. 60, XML data has a hierarchical structure, and a “people” tag has, as its child elements, “cast” indicating a cast name, “actor” indicating an actor name, and the like (in this case, for example, “<people>person's name” is an upper layer, and “<cast>cast name” and “<actor>actor name” are lower layers). Since the XML data has the hierarchical structure, easy access to assumed Vclick data can be made by the selection search that traces the upper to lower layers (returning from the lower layer to the upper layers in the middle of tracing layers downstream in some cases).

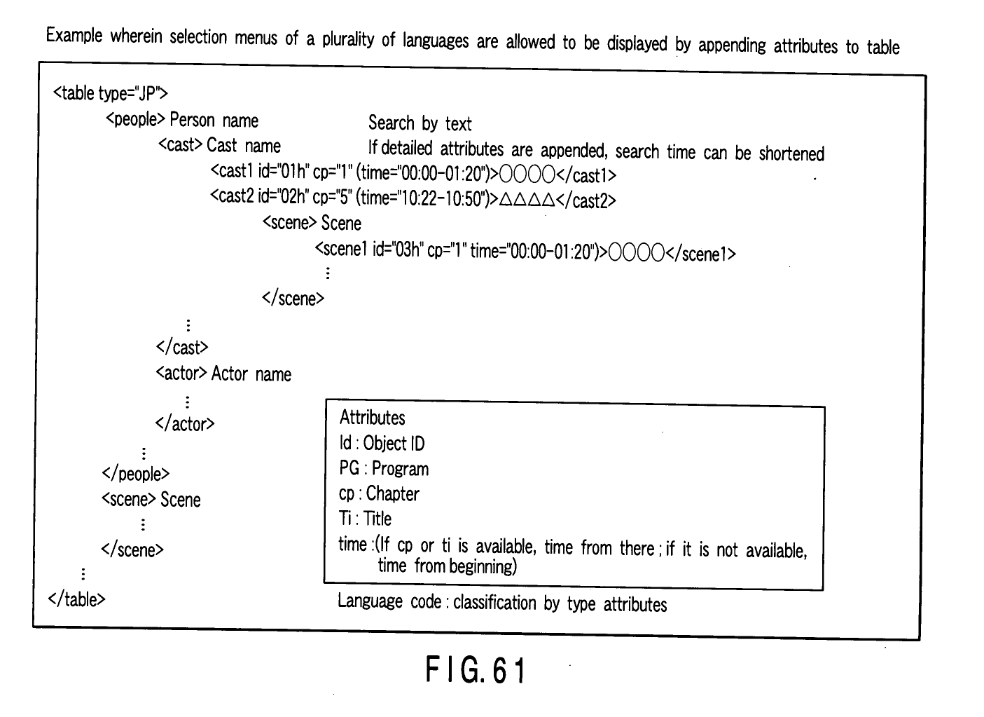

FIG. 61 is a view for explaining an example (part 4) of the configuration of a search table according to the embodiment of the present invention. In the example of FIG. 61, the hierarchical structure of FIG. 60 is made deeper. In this example, target Vclick data can be easily accessed by selecting in turn “person's name”→“cast name”→“scene”.

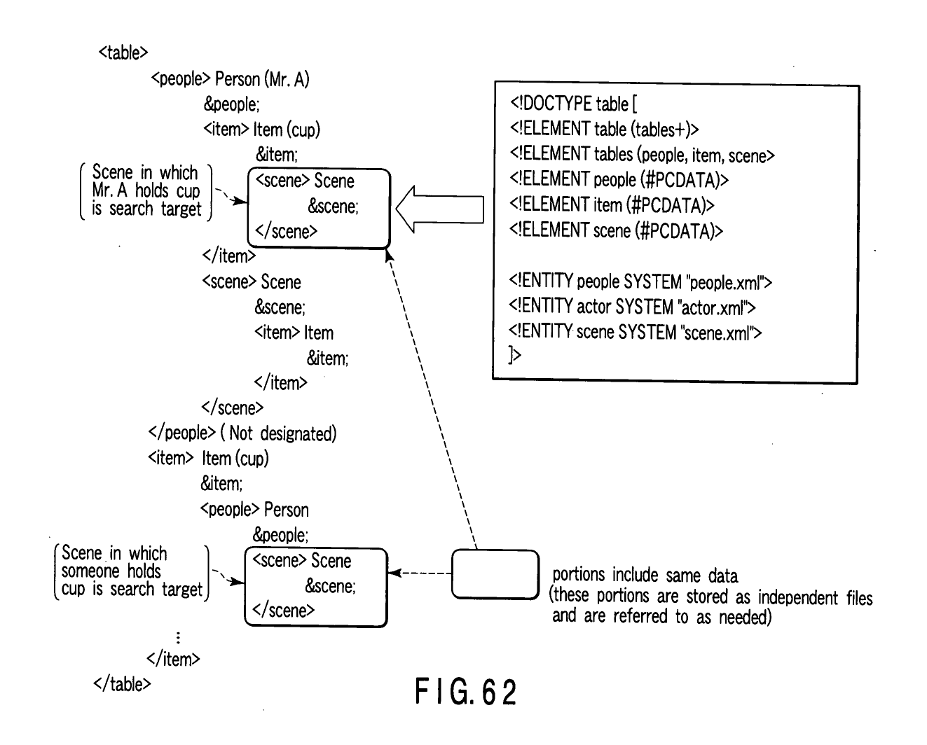

FIG. 62 is a view for explaining an example (part 5) of the configuration of a search table according to the embodiment of the present invention. In this example, the contents of “scene” in case of “person”→“item”→“scene” may be the same as those of “scene” in case of “item”→“person”→“scene” in some cases. Hence, in the example of FIG. 62, in order to allow reuse of identical data, respective elements are independently prepared (as independent files) and identical data (data of “scene” where someone has an item “cup” in the example of FIG. 62) is repetitively referred to as needed, thus allowing reuse.

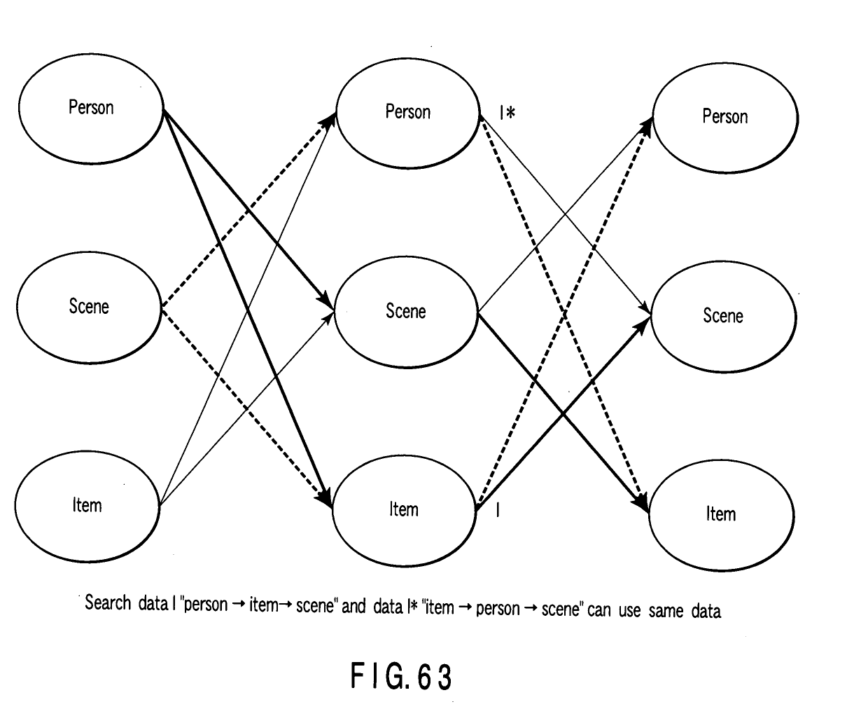

FIG. 63 is a view for explaining an example of a case wherein the same data is repetitively used in different scenes when the search table according to the embodiment of the present invention is used. This example shows by a diagram that person search data I* and item search data I can be commonly used (repetitively used) in a search sequence “person→item→scene” and that “item→person→scene”.

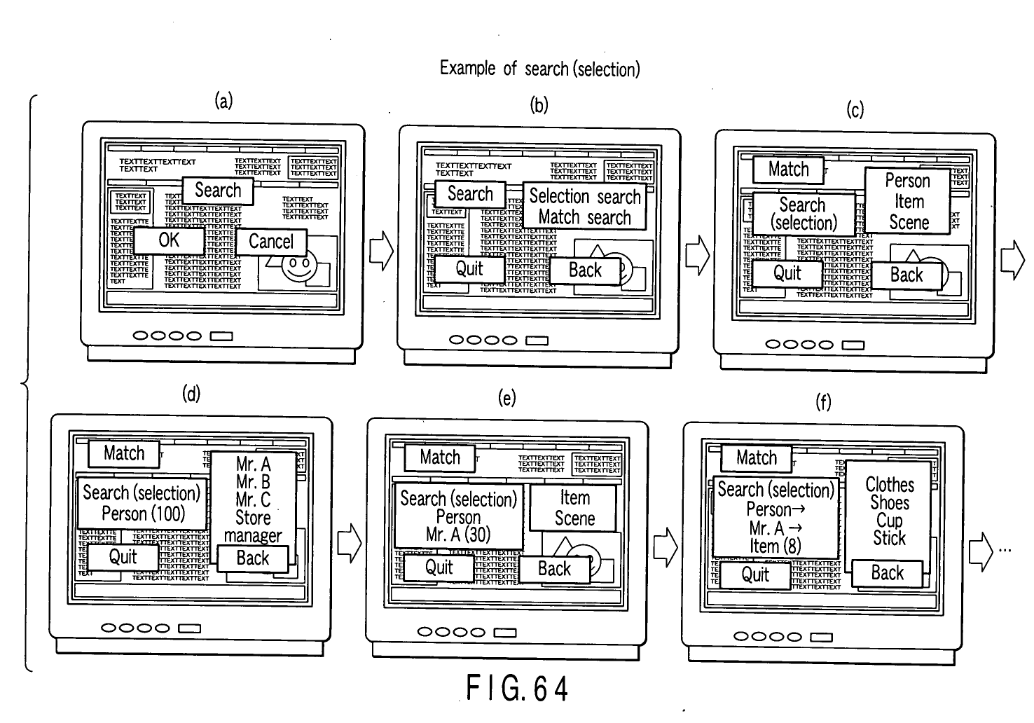

FIG. 64 is a view for explaining a search method (selection search) according to the embodiment of the present invention. That is, (a) a search is started by a user's operation→(b) the user selects the selection or match search→(c) if the user selects the selection search, choices “person”, “item”, and “scene” are displayed→(d) if the user selects “person”, next choices “Mr. A”, “Mr. B”, . . . are displayed→(e) if the user selects “Mr. A”, next choices “clothes”, “shoes”, “cup”, and the like are displayed.

If the user selects to quit the search operation in the middle of the hierarchical structure of the search sequence, all search hits so far can be displayed. Previous choices can be displayed stage by stage by clicking “back”. If the user selects “match” on the left corner of the screen, he or she can perform a match search within choices which are narrowed down to current hits. Note that a numerical value displayed within parentheses in FIG. 64(e) (e.g., “30” in “Mr. A (30)” in FIG. 64(e)) exemplifies the number of current search hits.

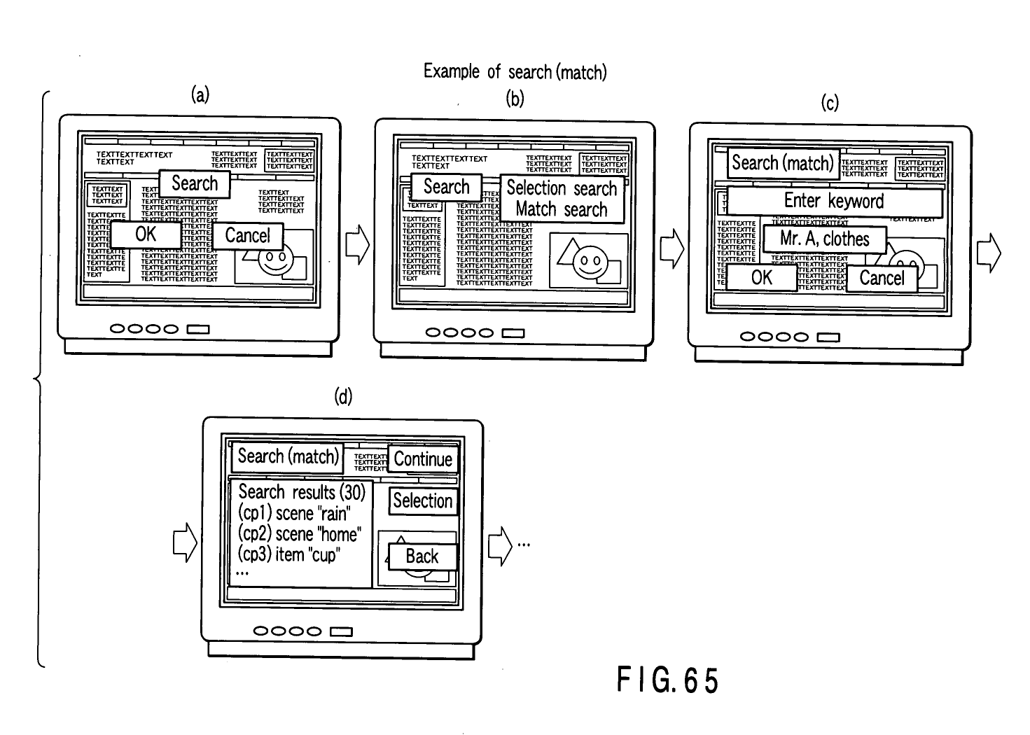

FIG. 65 is a view for explaining a search method (match search) according to the embodiment of the present invention. This figure exemplifies a sequence when the user makes a match search of keywords. That is, (a) a search is started by a user's operation→(b) the user selects the selection or match search→(c) if the user selects the match search, a keyword input field is displayed→(d) as a result of input of, e.g., “Mr. A, cloths” as search keywords, search hits are displayed. If the user selects “continue” in (d), he or she can continue to input other keywords. Alternatively, by selecting “selection” in (d), the user can make a selection search within current search hits. Note that (30) displayed behind “search result” in (d) exemplifies the number of current search hits.

The protocol between the server and client will be explained below. As the protocol used upon transmitting Vclick data from server 201 to client 200, for example, Real-time Transport Protocol (RTP) is known. Since RTP has good compatibility with UDP/IP and lays emphasis or realtime integrity, packets are likely to be omitted. If RTP is used, Vclick stream VCS is divided into transmission packets (RTP packets) when it is transmitted. An example of a method of storing Vclick stream VCS in transmission packets will be explained below.

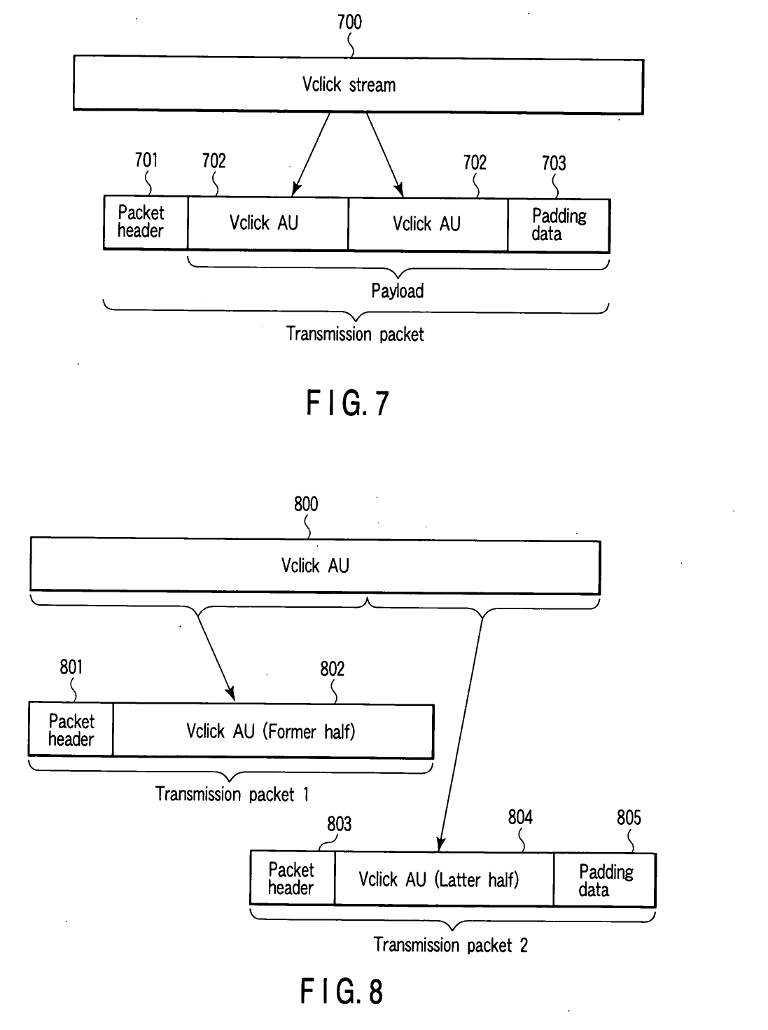

FIGS. 7 and 8 are views for explaining a method of forming transmission packets in correspondence with the small and large data sizes of Vclick_AUs, respectively. In FIG. 7, reference numeral 700 denotes Vclick stream VCS. A transmission packet includes packet header 701 and payload. Packet header 701 includes the serial number of the packet, transmission time, source specifying information, and the like. The payload is a data area for storing transmission data. Vclick_AUs (702) extracted in turn from Vclick stream 700 are stored in the payload. When the next Vclick_AU cannot be stored in the payload, padding data 703 is inserted in the remaining area. The padding data is dummy data to adjust the data size, and a run of “0” values. When the payload size can be set to be equal to that of one or a plurality of Vclick_AUs, no padding data is required.

On the other hand, FIG. 8 shows a method of forming transmission packets when one Vclick_AU cannot be stored in a payload. Only partial data (802) that can be stored in a payload of the first transmission packet of a Vclick_AU (800) is stored in the payload. The remaining data (804) is stored in a payload of the second transmission packet. If the storage size of the payload still has a free space, that space is padded with padding data 805. The same applies to a case wherein one Vclick_AU is divided into three or more packets.

As a protocol other than RTP, Hypertext Transfer Protocol (HTTP) or Secure Hypertext Transfer Protocol (HTTPS) may be used. HTTP has good compatibility with TCP/IP and omitted data is re-sent, thus allowing highly reliable data communications. However, when the network throughput is low, a data delay may occur. Since HTTP is free from any data omission, a method of dividing Vclick stream VCS into packets upon storage need not be particularly taken into consideration.

(Playback Procedure [Network])

The procedures of a playback process when Vclick stream VCS is present on server 201 will be described below.

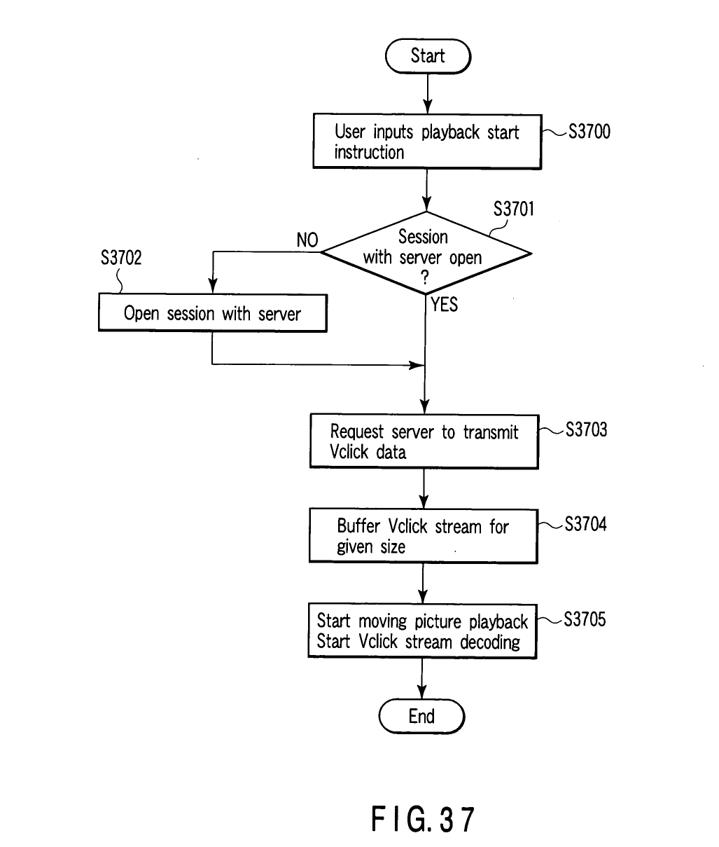

FIG. 37 is a flowchart showing the playback start process procedures after the user inputs a playback start instruction until playback starts. In step S3700, the user inputs a playback start instruction. This input is received by interface handler 207, which outputs a moving picture playback preparation command to moving picture playback controller 205. It is checked as branch process step S3701 if a session with server 201 has already been opened. If the session has not been opened yet, the flow advances to step S3702; otherwise, the flow advances to step S3703. In step S3702, a process for opening the session between the server and client is executed.

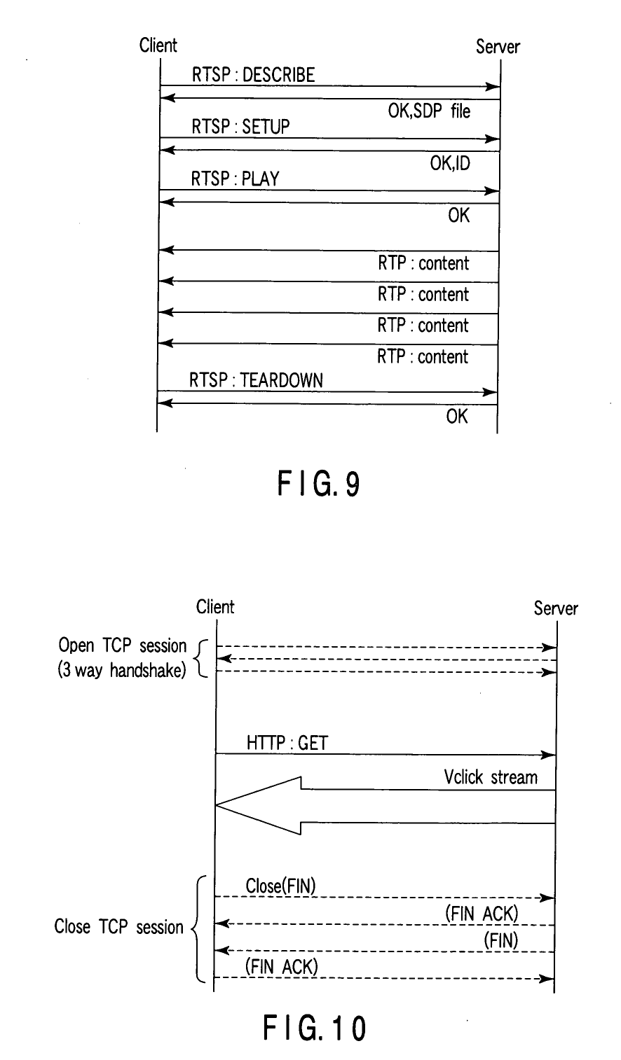

FIG. 9 shows an example of communication procedures from session open until session close when RTP is used as the communication protocol between the server and client. A negotiation must be done between the server and client at the beginning of the session. In the case of RTP, Real Time Streaming Protocol (RTSP) is normally used. Since an RTSP communication requires high reliability, RTSP and RTP preferably make communications using TCP/IP and UDP/IP, respectively. In order to open a session, the client (200 in the example of FIG. 2) requests the server (201 in the example of FIG. 2) to provide information associated with Vclick data to be streamed (RTSP DESCRIBE method).

Assume that the client (200) is notified in advance of the address of the server (201) that distributes data corresponding to a moving picture to be played back by a method of, e.g., recording address information on a moving picture data recording medium. Server 201 sends information of Vclick data to client 200 as a response to this request. More specifically, the server sends, to the client, information such as the protocol version of the session, session owner, session name, connection information, session time information, metadata name, metadata attributes, and the like. As a method of describing these pieces of information, for example, Session Description Protocol (SDP) is used. Client 200 then requests server 201 to open a session (RTSP SETUP method). Server 201 prepares for streaming, and returns a session ID to client 200. The processes described so far correspond to those in step S3702 when RTP is used.

When HTTP is used in place of RTP, the communication procedures are made, as shown in, e.g., FIG. 10. Initially, a TCP session as a lower layer of HTTP is opened (three-way handshake). As in the above procedures, assume that the client (200) is notified in advance of the address of the server (201) which distributes data corresponding to a moving picture to be played back. After that, a process for sending status information (e.g., a manufacturing country, language, selection states of various parameters, and the like) of client 200 to server 201 using, e.g., SDP may be executed. The processes described so far correspond to those in step S3702 in case of HTTP.

In step S3703, a process for requesting the server (201) to transmit Vclick data is executed while the session between server 201 and client 200 is open. This process is implemented by sending an instruction from interface handler 207 to network manager 208, and then sending a request from network manager 208 to the server (201). In the case of RTP, network manager 208 sends an RTSP PLAY method to the server to issue a Vclick data transmission request. The server specifies Vclick stream VCS to be transmitted with reference to information received from the client so far and Vclick Info VCI in the server. Furthermore, the server specifies a transmission start position in Vclick stream VCS using time stamp information of the playback start position included in the Vclick data transmission request and Vclick access table VCS stored in the server. The server then packetizes Vclick stream VCS and sends packets to the client by RTP.

On the other hand, in the case of HTTP, network manager 208 transmits an HTTP GET method to issue a Vclick data transmission request. This request may include time stamp information of the playback start position of a moving picture. The server specifies Vclick stream VCS to be transmitted and the transmission start position in this stream by the same method as in RTP, and sends Vclick stream VCS to the client by HTTP.

In step S3704, a process for buffering Vclick stream VCS sent from the server on buffer 209 is executed. This process is done to prevent buffer 209 from being emptied when Vclick stream transmission from the server is too late during playback of Vclick stream VCS. If metadata manager 210 notifies the interface handler that the buffer has stored sufficient Vclick stream VCS, the flow advances to step S3705. In step S3705, the interface handler issues a moving picture playback start command to controller 205 and also issues a command to metadata manager 210 to start output of Vclick stream VCS to metadata decoder 217.

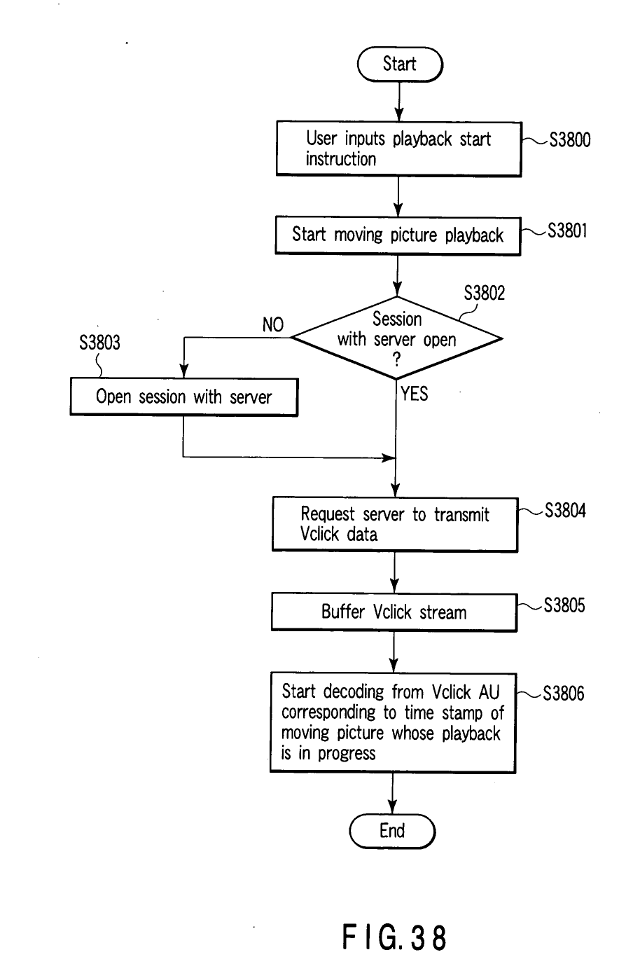

FIG. 38 is a flowchart showing the procedures of the playback start process different from those in FIG. 37. In the processes described in the flowchart of FIG. 37, the process for buffering Vclick stream VCS for a given size in step S3704 often takes time depending on the network status, and the processing performance of the server and client. More specifically, a long time is often required after the user issues a playback instruction until playback starts actually. In the process procedures shown in FIG. 38, if the user issues a playback start instruction in step S3800, playback of a moving picture immediately starts in step S3801. That is, upon reception of the playback start instruction from the user, interface handler 207 immediately issues a playback start command to controller 205. In this way, the user need not wait after he or she issues a playback instruction until he or she can view a moving picture. Process steps S3802 to S3805 are the same as those in steps S3701 to S3704 in FIG. 37.

In step S3806, a process for decoding Vclick stream VCS in synchronism with the moving picture whose playback is in progress is executed. More specifically, upon reception of a message indicating that a given size of Vclick stream VCS is stored in buffer 209 from metadata manager 210, interface handler 207 outputs, to metadata manager 210, an output start command of Vclick stream VCS to metadata decoder 217. Metadata manager 210 receives the time stamp of the moving picture whose playback is in progress from the interface handler, specifies a Vclick_AU corresponding to this time stamp from data stored in the buffer, and outputs it to metadata decoder 217.

In the process procedures shown in FIG. 38, the user never waits after he or she issues a playback instruction until he or she can view a moving picture. However, since Vclick stream VCS is not decoded immediately after the beginning of playback, no display associated with objects cannot be made, or no action is taken if the user clicks an object.

The aforementioned problem is solved after decoding of Vclick stream VCS starts after the beginning of moving picture playback. Hence, if the period until a predetermined size of VCS (Vclick_AU) is decoded after the beginning of playback is shortened inasmuch as the user does not get irritated, the above problem can be solved in practice. Hence, client 200 and server 201 may have an always-on connecter via a high-speed line, and the processes in steps S3802 and S3803 may be executed as background processes in advance when a DVD disc that uses Vclick is loaded into disc device 230 (or after a title to be played back is selected from the loaded disc). In this case, if a user instruction is input in step S3800, DVD playback in step S3801 immediately starts. At the same time, the processes in steps S3802 and S3803 are skipped, and downloading of Vclick stream VCS into the buffer via the high-speed line immediately starts (steps S3804 and S3805). If the downloaded size has reached a predetermined size (e.g., 12 Kbytes), decoding of Vclick stream VCS (the first Vclick_AU in that stream) starts (step S3806).

During playback of the moving picture, network manager 208 of client 200 receives Vclick streams which are sent in turn from server 201, and stores them in buffer 209. The stored object metadata are sent to metadata decoder 217 at appropriate timings. That is, metadata manager 210 refers to the time stamp of the moving picture whose playback is in progress, which is sent from interface handler 207 to specify a Vclick_AU corresponding to that time stamp from data stored in buffer 209, and sends the specified object metadata to metadata decoder 217 for respective AUs. Metadata decoder 217 decodes the received data. Note that decoder 217 may skip decoding of data for a camera angle different from that currently selected by client 200. When it is known that the Vclick_AU corresponding to the time stamp of the moving picture whose playback is in progress has already been loaded into metadata decoder 217, the transmission process of object metadata to metadata decoder 217 may be skipped.

The time stamp of the moving picture whose playback is in progress is sequentially sent from interface handler 207 to metadata decoder 217. Metadata decoder 217 decodes the Vclick_AU in synchronism with this time stamp, and sends required data to AV renderer 218. For example, when attribute information described in the Vclick_AU instructs to display an object region, the metadata decoder generates a mask image, contour, and the like of the object region, and sends them to AV renderer 218 in synchronism with the time stamp of the moving picture whose playback is in progress. Metadata decoder 217 compares the time stamp of the moving picture whose playback is in progress with the lifetime of the Vclick_AU to determine old object metadata which is not required and to delete that data.

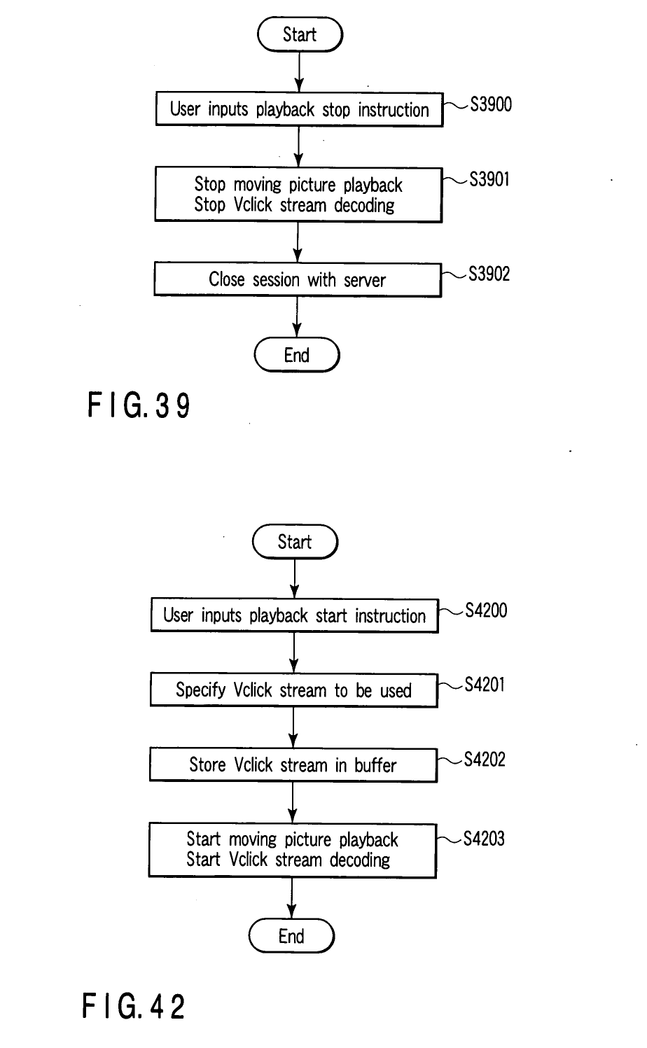

FIG. 39 is a flowchart for explaining the procedures of a playback stop process. In step S3900, the user inputs a playback stop instruction during playback of the moving picture. In step S3901, a process for stopping the moving image playback process is executed. This process is done when interface handler 207 outputs an stop command to controller 205. At the same time, the interface handler outputs, to metadata manager 210, an output stop command of object metadata to metadata decoder 217.

In step S3902, a process for closing the session with the server (201) is executed. When RTP is used, an RTSP TEARDOWN method is sent to the server, as shown in FIG. 9. Upon reception of the TEARDOWN message, server 201 stops data transmission to close the session, and returns a confirmation message to client 200. With this process, the session ID used in the session is invalidated. On the other hand, when HTTP is used, an HTTP Close method is sent to the server (201) to close the session, as shown in FIG. 10.

(Random Access Procedure [Network])

The random access playback procedures when Vclick stream VCS is present on server 201 will be described below.

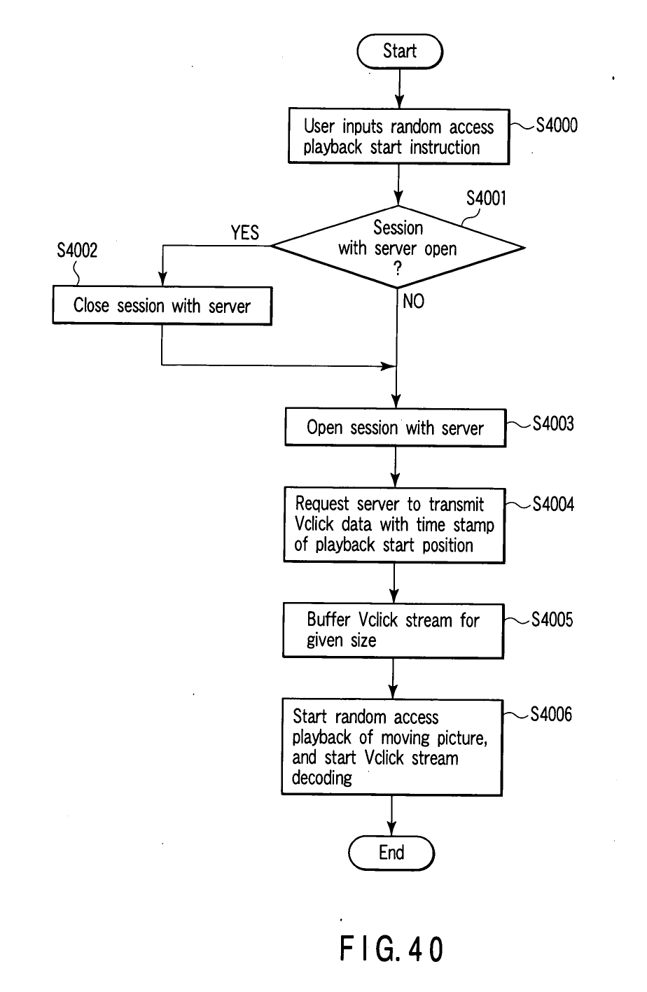

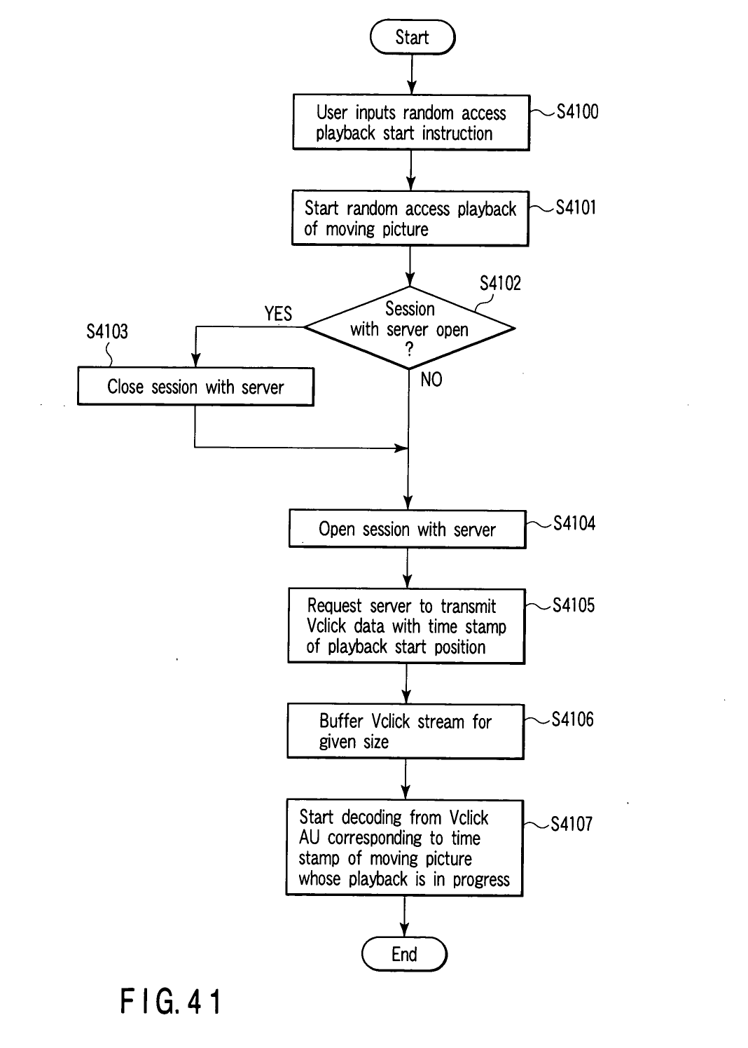

FIG. 40 is a flowchart showing the process procedures after the user issues a random access playback start instruction until playback starts. In step S4000, the user inputs a random access playback start instruction. As the input methods, a method of making the user select from a list of accessible positions such as chapters and the like, a method of making the user designate one point from a slide bar corresponding to the time stamps of a moving picture, a method of directly inputting the time stamp of a moving picture, and the like are available. The input time stamp is received by interface handler 207, which issues a moving picture playback preparation command to moving picture playback controller 205. If playback of the moving picture has already started, interface handler 207 issues a playback stop instruction of the moving picture whose playback is in progress, and then outputs the moving picture playback preparation command. It is checked as branch process step S4001 if a session with server 201 has already been opened. If the session has already been opened (e.g., playback of the moving image is in progress), a session close process is executed in step S4002. If the session has not been opened yet, the flow advances to step S4003 without executing the process in step S4002. In step S4003, a process for opening the session between the server (201) and client (200) is executed. This process is the same as that in step S3702 in FIG. 37.

In step S4004, a process for requesting the server (201) to transmit Vclick data by designating the time stamp of the playback start position is executed while the session between server 201 and client 200 is open. This process is implemented by sending an instruction from interface handler 207 to network manager 208, and then sending a request from network manager 208 to the server (201). In case of RTP, network manager 208 sends an RTSP PLAY method to the server to issue a Vclick data transmission request. At this time, manager 208 also sends the time stamp that specifies the playback start position to the server (201) by a method using, e.g., a Range description. Server 201 specifies an object metadata stream to be transmitted with reference to information received from the client (200) so far and Vclick Info VCI in server 201. Furthermore, server 201 specifies a transmission start position in Vclick stream VCS using time stamp information of the playback start position included in the Vclick data transmission request and Vclick access table VCA stored in server 201. Server 201 then packetizes Vclick stream VCS and sends packets to client 200 by RTP.

On the other hand, in the case of HTTP, network manager 208 transmits an HTTP GET method to issue a Vclick data transmission request. This request includes time stamp information of the playback start position of the moving picture. Server 201 specifies Vclick stream VCS to be transmitted with reference to Vclick information file VCI, and also specifies the transmission start position in Vclick stream VCS using Vclick access table VCA in server 201 by the same method as in RTP. Server 201 then sends Vclick stream VCS to client 200 by HTTP.

In step S4005, a process for buffering Vclick stream VCS sent from the server (201) on buffer 209 is executed. This process is done to prevent buffer 209 from being emptied when Vclick stream transmission from the server (201) is too late during playback of Vclick stream VCS. If metadata manager 210 notifies the interface handler that buffer 209 has stored sufficient Vclick stream VCS, the flow advances to step S4006. In step S4006, interface handler 207 issues a moving picture playback start command to controller 205 and also issues a command to metadata manager 210 to start output of Vclick stream VCS to metadata decoder 217.

FIG. 41 is a flowchart showing the procedures of the random access playback start process different from those in FIG. 40. In the processes described in the flowchart of FIG. 40, the process for buffering Vclick stream VCS for a given size in step S4005 often takes time depending on the network status, and the processing performance of the server/client (201/200). More specifically, a long time is often required after the user issues a playback instruction until playback starts actually in step S4006 (such a long processing time often irritates the user).

In contrast, in the process procedures shown in FIG. 41, if the user issues a playback start instruction in step S4100, playback of a moving picture immediately starts in step S4101. That is, upon reception of the playback start instruction from the user, interface handler 207 immediately issues a random access playback start command to controller 205. In this way, the user need not wait after he or she issues a playback instruction until he or she can view a moving picture. Process steps S4102 to S4106 are the same as those in steps S4001 to S4005 in FIG. 40.

In step S4107, a process for decoding Vclick stream VCS in synchronism with the moving picture whose playback is in progress is executed. More specifically, upon reception of a message indicating that a given size of Vclick stream VCS is stored in buffer 209 from metadata manager 210, interface handler 207 outputs, to metadata manager 210, an output start command of Vclick stream VCS to metadata decoder 217. Metadata manager 210 receives the time stamp of the moving picture whose playback is in progress from interface handler 207, specifies a Vclick_AU corresponding to this time stamp from data stored in buffer 209, and outputs it to metadata decoder 217.

In the process procedures shown in FIG. 41, the user never has to wait after he or she issues a playback instruction until he or she can view a moving picture. However, since Vclick stream VCS is not decoded immediately after the beginning of playback, no display associated with objects can be made, or no action is taken if the user clicks an object.

The aforementioned problem is solved after decoding of Vclick stream VCS starts since the beginning of moving picture playback. Hence, if a period until decoding of VCS starts after the beginning of playback is shortened inasmuch as the user does not get irritated, the above problem can be solved in practice. Hence, client 200 and server 201 may be always-on connected via a high-speed line, and the processes in steps S4102 to S4104 may be executed as background processes in advance when a DVD disc that uses Vclick is loaded into disc device 230 (or after a title to be played back is selected from the loaded disc). In this case, if a user instruction is input in step S4100, DVD playback in step S4101 immediately starts. At the same time, the processes in steps S4102 to S4104 are skipped, and downloading of Vclick stream VCS into the buffer via the high-speed line immediately starts (step S4106). If the downloaded size has reached a predetermined size (e.g., 12 Kbytes), decoding of Vclick stream VCS (the first Vclick_AU in that stream) starts (step S4107). Since the processes during playback of the moving picture and moving picture playback stop process are the same as those in the normal DVD playback process, description thereof will be omitted.

(Playback Procedure [Local])

The procedures of a playback process when Vclick stream VCS is present on moving picture data recording medium 231 will be described below.

FIG. 42 is a flowchart showing the playback start process procedures after the user inputs a playback start instruction until playback starts. In step S4200, the user inputs a playback start instruction. This input is received by interface handler 207, which outputs a moving picture playback preparation command to moving picture playback controller 205. In step S4201, a process for specifying Vclick stream VCS to be used is executed. In this process, the interface handler refers to Vclick information file VCI on moving picture data recording medium 231 and specifies Vclick stream VCS corresponding to the moving picture to be played back designated by the user.

In step S4202, a process for storing Vclick stream VCS in the buffer is executed. To implement this process, interface handler 207 issues, to metadata manager 210, a command for assuring a buffer. The buffer size to be assured is determined as a size large enough to store the specified Vclick stream VCS. Normally, a buffer initialization document that describes this size is recorded on moving picture data recording medium 231. If no buffer initialization document is stored, a predetermined size is applied. Upon completion of assuring of the buffer, interface handler 207 issues, to controller 205, a command for reading out the specified Vclick stream VCS and storing it in the buffer.

After Vclick stream VCS is stored in buffer 209, a playback start process is executed in step S4203. In this process, interface handler 207 issues a moving picture playback command to moving picture playback controller 205, and simultaneously issues, to metadata manager 210, an output start command of Vclick stream VCS to metadata decoder 217.

During playback of the moving picture, Vclick_AUs read out from moving picture data recording medium 231 are stored in buffer 209. The stored Vclick stream VCS is sent to metadata decoder 217 at an appropriate timing. That is, metadata manager 210 refers to the time stamp of the moving picture whose playback is in progress, which is sent from interface handler 207 to specify a Vclick_AU corresponding to that time stamp from data stored in buffer 209, and sends the specified Vclick_AU to metadata decoder 217. Metadata decoder 217 decodes the received data. Note that decoder 217 may skip decoding of data for a camera angle different from that currently selected by the client. When it is known that the Vclick_AU corresponding to the time stamp of the moving picture whose playback is in progress has already been loaded into metadata decoder 217, the transmission process of Vclick stream VCS to metadata decoder 217 may be skipped.

The time stamp of the moving picture whose playback is in progress is sequentially sent from the interface handler to metadata decoder 217. Metadata decoder 217 decodes the Vclick_AU in synchronism with this time stamp, and sends required data to AV renderer 218. For example, when attribute information described in the AU of the object metadata instructs to display an object region, the metadata decoder generates a mask image, contour, and the like of the object region, and sends them to AV renderer 218 in synchronism with the time stamp of the moving picture whose playback is in progress. Metadata decoder 217 compares the time stamp of the moving picture whose playback is in progress with the lifetime of the Vclick_AU to determine old object metadata which is not required, and deletes that data.

If the user inputs a playback stop instruction during playback of the moving picture, interface handler 207 outputs a moving picture playback stop command and a read stop command of Vclick stream VCS to controller 205. With these commands, the moving picture playback process ends.

(Random Access Procedure [Local])

The random access playback procedures when Vclick stream VCS is present on moving picture data recording medium 231 will be described below.

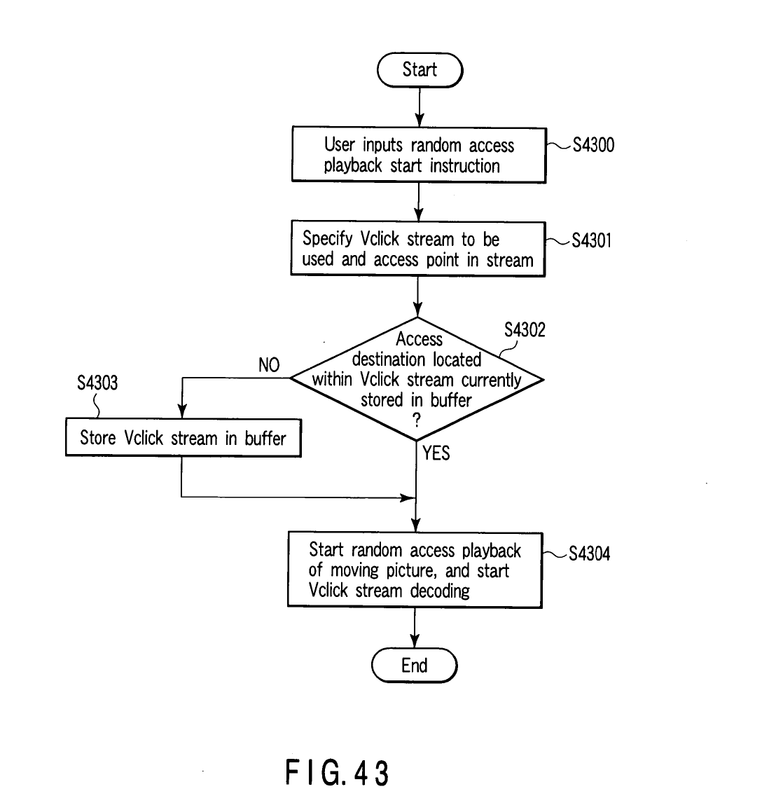

FIG. 43 is a flowchart showing the process procedures after the user issues a random access playback start instruction until playback starts. In step S4300, the user inputs a random access playback start instruction. As the input methods, a method of making the user select from a list of accessible positions such as chapters and the like, a method of making the user designate one point from a slide bar corresponding to the time stamps of a moving picture, a method of directly inputting the time stamp of a moving picture, and the like are available. The input time stamp is received by interface handler 207, which issues a moving picture playback preparation command to moving picture playback controller 205.

In step S4301, a process for specifying Vclick stream VCS to be used is executed. In this process, the interface handler refers to Vclick information file VCI on moving picture data recording medium 231 and specifies Vclick stream VCS corresponding to the moving picture to be played back designated by the user. Furthermore, the interface handler refers to Vclick access table VCA on moving picture data recording medium 231 or that loaded in a memory (buffer 209 or another work memory area), and specifies an access point in Vclick stream VCS corresponding to the random access destination of the moving picture.

Step S4302 is a branch process that checks if the specified Vclick stream VCS is currently loaded into buffer 209. If the specified Vclick stream is not loaded into the buffer, the flow advances to step S4304 after a process in step S4303. If the specified Vclick stream is currently loaded into the buffer, the flow advances to step S4304 while skipping the process in step S4303. In step S4304, random access playback of the moving picture and decoding of Vclick stream VCS start. In this process, interface handler 207 issues a moving picture random access playback command to moving picture playback controller 205, and simultaneously outputs, to metadata manager 210, a command to start output of Vclick stream VCS to metadata decoder 217. After that, the decoding process of Vclick stream VCS is executed in synchronism with playback of the moving picture. Since the processes during playback of the moving picture and moving picture playback stop process are the same as those in the normal playback process, description thereof will be omitted.

(Procedure from Clicking Until Related Information Display)

The operation of the client executed when the user has clicked a position within an object region using a pointing device such as a mouse or the like will be described below. When the user has clicked a given position, the clicked coordinate position on the moving picture is input to interface handler 207. Interface handler 207 sends the time stamp and coordinate position of the moving picture upon clicking to metadata decoder 217. Metadata decoder 217 executes a process for specifying an object designated by the user on the basis of the time stamp and coordinate position.

Since metadata decoder 217 decodes Vclick stream VCS in synchronism with playback of the moving picture, and has already generated the region of the object at the time stamp upon clicking, it can easily implement this process. When a plurality of object regions are present at the clicked coordinate position, the frontmost object is specified with reference to layer information included in a Vclick_AU.

After the object designated by the user is specified, metadata decoder 217 sends an action description (a script that designates an action) described in object attribute information 403 to script interpreter 212. Upon reception of the action description, script interpreter 212 interprets the action content and executes an action. For example, the script interpreter displays a designated HTML file or begins to play back a designated moving picture. These HTML file and moving picture data may be recorded on client 200, may be sent from server 201 via the network, or may be present on another server on the network.

(Detailed Data Structure)

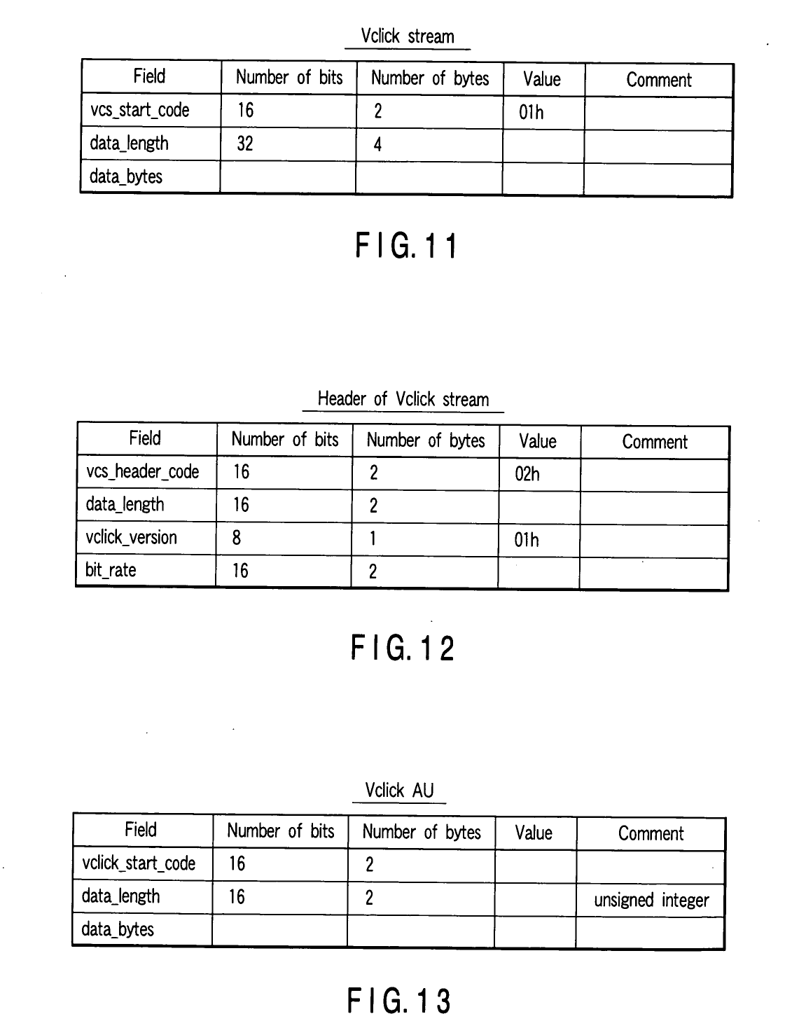

Configuration examples of practical data structures will be explained below. FIG. 11 shows an example of the data structure of Vclick stream VCS (506 in FIG. 5). The meanings of data elements are:

vcs_start_code indicates the start of Vclick stream VCS;

data_length designates the data length of a field after data_length in this Vclick stream VCS using bytes as a unit; and

data_bytes corresponds to a data field of a Vclick_AU. This field includes header 507 (FIG. 5) of Vclick stream 506 at the head position, and one or a plurality of Vclick_AUs (FIG. 4) or NULL_AUs (FIG. 48) follow.

FIG. 12 shows an example of the data structure of the Vclick stream (header 507 of stream 506 in the example of FIG. 5). The meanings of data elements are:

vcs_header_code indicates the start of the header (507) of Vclick stream VCS (506);

data_length designates the data length of a field after data_length in the header of Vclick stream VCS using bytes as a unit;

vclick_version designates the version of the format. This value assumes 01h in this specification; and

bit_rate designates a maximum bit rate of this Vclick stream VCS.

FIG. 13 shows an example of the data structure of the Vclick_AU (rectangles 500 to 505 in the example of FIG. 5). The meanings of data elements are:

vclick_start_code indicates the start of each Vclick_AU;

data_length designates the data length of a field after data_length in this Vclick_AU using bytes as a unit; and

data_bytes corresponds a data field of the Vclick_AU. This field includes header 401, time stamp 402, object attribute information 403, and object region information 400.

FIG. 14 shows an example of the data structure of header 401 (FIG. 4) of the Vclick_AU. The meanings of data elements are:

vclick_header_code indicates the start of the header of each Vclick_AU;

data_length designates the data length of a field after data_length in the header of this Vclick_AU using bytes as a unit;

filtering_id is an ID used to identify the Vclick_AU. This data is used to determine the Vclick_AU to be decoded on the basis of the attributes of the client and this ID;

object_id is an identification number of an object described in Vclick data. When the same object_id value is used in two Vclick_AUs, they are data for a semantically identical object;

object_subid represents semantic continuity of objects. When two Vclick_AUs include the same object_id and object_subid values, they mean continuous objects;

continue_flag is a flag. If this flag is “1”, an object region described in this Vclick_AU is continuous with that described in the next Vclick_AU having the same object_id. Otherwise, this flag is “0”; and

layer represents a layer value of an object. As the layer value is larger, this means that an object is located on the front side on the screen. As described above, since “the Vclick_AU to be decoded” can be determined based on filtering_id, “Vclick stream VCS including the Vclick_AU to be decoded” can also be identified based on filtering_id. That is, “stream selection of moving picture metadata” can be made using filtering_id.

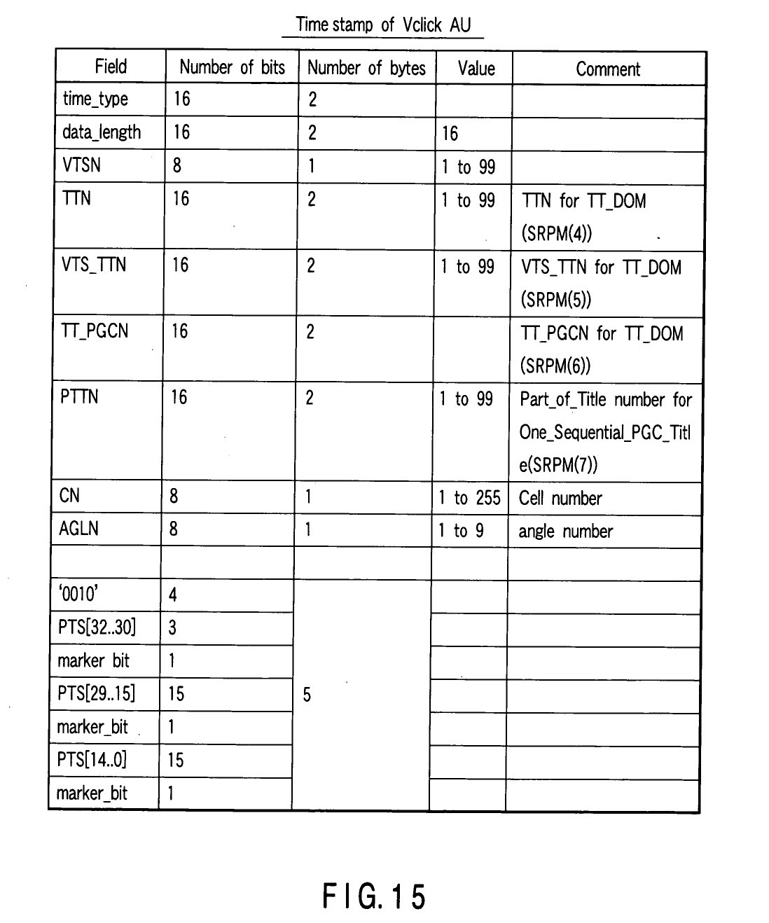

FIG. 15 shows an example of the data structure of the time stamp (402 in FIG. 4) of the Vclick_AU. This example assumes a case wherein a DVD is used as the moving picture data recording medium. Using the following time stamp, an arbitrary time of a moving picture on the DVD can be designated, and synchronization between the moving picture and Vclick data can be attained. The meanings of data elements are:

time_type indicates the start of a DVD time stamp;

data_length designates the data length of a field after data_length in this time stamp using bytes as a unit;

VTSN indicates the video title set (VTS) number of DVD-Video;

TTN indicates a title number in the title domain of DVD-Video. This number corresponds to a value stored in system parameter SPRM(4) of a DVD player;

VTS_TTN indicates a VTS title number in the title domain of DVD-Video. This number corresponds to a value stored in system parameter SPRM(5) of the DVD player;

TT_PGCN indicates a title program chain (PGC) number in the title domain of DVD-Video. This number corresponds to a value stored in system parameter SPRM(6) of the DVD player;

PTTN indicates a part-of-title (Part_of_Title) number of DVD-Video. This number corresponds to a value stored in system parameter SPRM(7) of the DVD player;

CN indicates a cell number of DVD-Video;

AGLN indicates an angle number of DVD-Video; and

PTS(s . . . e] indicates data of s-th to e-th bits of the display time stamp of DVD-Video.

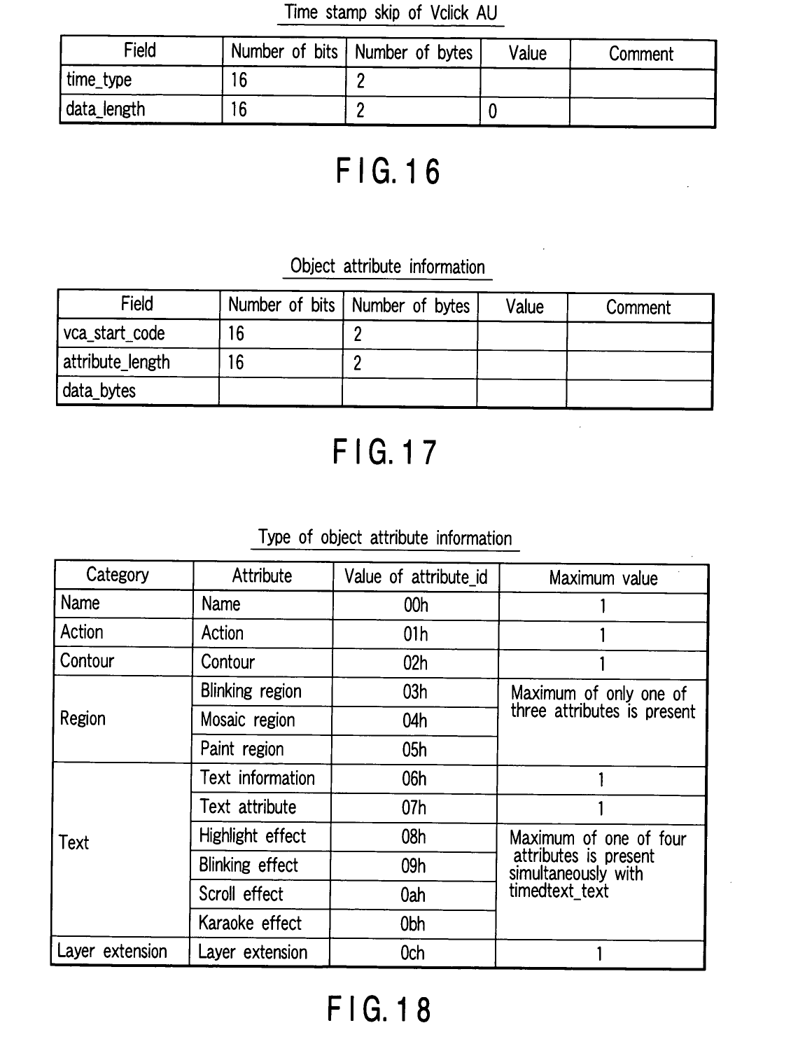

FIG. 16 shows an example of the data structure of time stamp skip of the Vclick_AU. When the time stamp skip is described in the Vclick_AU in place of a time stamp, this means that the time stamp of this Vclick_AU is the same as that of the immediately preceding Vclick_AU. The meanings of data elements are:

time_type indicates the start of the time stamp skip; and

data_length designates the data length of a field after data_length of this time stamp skip using bytes as a unit. However, this value always assumes “0” since the time stamp skip includes only time_type and data_length.

FIG. 17 shows an example of the data structure of object attribute information 403 (FIG. 4) of the Vclick_AU. The meanings of data elements are:

vca_start_code indicates the start of the object attribute information of each Vclick_AU;

data_length designates the data length of a field after data_length in this object attribute information using bytes as a unit; and

data_bytes corresponds to a data field of the object attribute information. This field describes one or a plurality of attributes.

Details of attribute information described in object attribute information 403 will be described below. FIG. 18 shows a list of the types of attributes that can be described in object attribute information 403. A column “maximum value” describes an example of the maximum number of data that can be described in one object metadata AU for each attribute.

attribute_id is an ID included in each attribute data, and is data used to identify the type of attribute. A name attribute is information used to specify the object name. An action attribute describes an action to be taken upon clicking an object region in a moving picture. A contour attribute indicates a display method of an object contour. A blinking region attribute specifies a blinking color upon blinking an object region. A mosaic region attribute describes a mosaic conversion method upon applying mosaic conversion to an object region, and displaying the converted region. A paint region attribute specifies a color upon painting and displaying an object region.

Attributes which belong to a text category define those associated with characters to be displayed when characters are to be displayed on a moving picture. Text information describes text to be displayed. A text attribute specifies attributes such as a color, font, and the like of text to be displayed. A highlight effect attribute specifies a highlight display method of characters upon highlighting partial or whole text. A blinking effect attribute specifies a blinking display method of characters upon blinking partial or whole text. A scroll effect attribute describes a scroll direction and speed upon scrolling text to be displayed. A karaoke effect attribute specifies the change timing and position of characters upon changing a text color sequentially.

Finally, a layer extension attribute is used to define the change timing and value of a change in layer value when the layer value of an object changes in the Vclick_AU. The data structures of the aforementioned attributes will be individually explained below.

FIG. 19 shows an example of the data structure of the name attribute of an object. The meanings of data elements are:

attribute_id designates a type of attribute data. The name attribute has attribute_id=00h;

data_length indicates the data length after data_length of the name attribute data using bytes as a unit;

language specifies a language used to describe the following elements (name and annotation). A language is designated using ISO-639 “code for the representation of names of languages”;

name_length designates the data length of a name element using bytes as a unit;

name is a character string, which represents the name of an object described in this Vclick_AU;

annotation_length represents the data length of an annotation element using bytes as a unit; and

annotation is a character string, which represents an annotation associated with an object described in this Vclick_AU.

FIG. 20 shows an example of the data structure of the action attribute of an object. The meanings of data elements are:

attribute_id designates a type of attribute data. The action attribute has attribute_id=01h;

data_length indicates the data length of a field after data_length of the action attribute data using bytes as a unit;

script_language specifies a type of script language described in a script element;

script_length represents the data length of the script element using bytes as a unit; and

script is a character string which describes an action to be executed using the script language designated by script_language when the user designates an object described in this Vclick_AU.

FIG. 21 shows an example of the data structure of the contour attribute of an object. The meanings of data elements are:

attribute_id designates a type of attribute data. The contour attribute has attribute_id=02h;

data_length indicates the data length of a field after data_length of the contour attribute data;

color_r, color_g, color_b, and color_a designate a display color of the contour of an object described in this object metadata AU;

color_r, color_g, and color_b respectively designate red, green, and blue values in RGB expression of the color. color_a indicates transparency;

line_type designates the type of contour (solid line, broken line, or the like) of an object described in this Vclick_AU; and

thickness designates the thickness of the contour of an object described in this Vclick_AU using points as a unit.

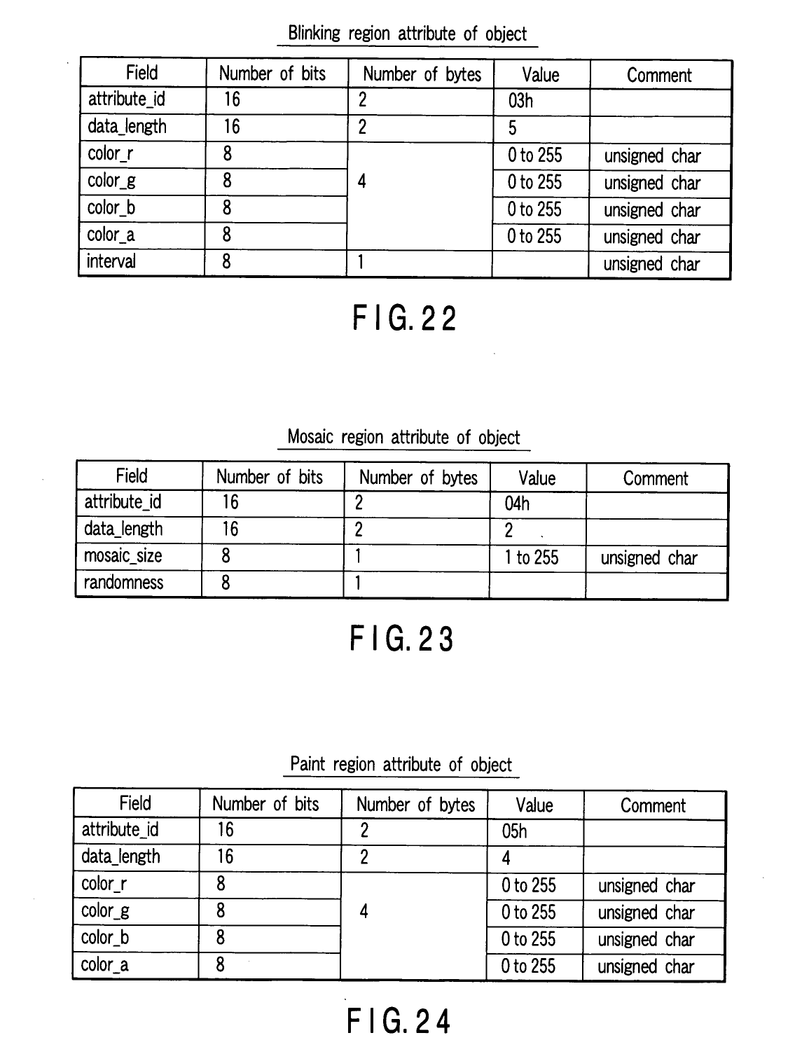

FIG. 22 shows an example of the data structure of the blinking region attribute of an object. The meanings of data elements are:

attribute_id designates a type of attribute data. The blinking region attribute data has attribute_id=03h;

data_length indicates the data length of a field after data_length of the blinking region attribute data using bytes as a unit;

color_r, color_g, color_b, and color_a designate a display color of a region of an object described in this Vclick_AU. color_r, color_g, and color_b respectively designate red, green, and blue values in RGB expression of the color. color_a indicates transparency. Blinking of an object region is realized by alternately displaying the color designated in the paint region attribute and that designated in this attribute; and

interval designates the blinking time interval.

FIG. 23 shows an example of the data structure of the mosaic region attribute of an object. The meanings of data elements are:

attribute_id designates a type of attribute data. The mosaic region attribute data has attribute_id=04h;

data_length indicates the data length of a field after data_length of the mosaic region attribute data using bytes as a unit;

mosaic_size designates the size of a mosaic block using pixels as a unit; and

randomness represents a degree of randomness upon replacing mosaic-converted block positions.

FIG. 24 shows an example of the data structure of the paint region attribute of an object. The meanings of data elements are:

attribute_id designates a type of attribute data. The paint region attribute data has attribute_id=05h;

data_length indicates the data length of a field after data_length of the paint region attribute data using bytes as a unit; and

color_r, color_g, color_b, and color_a designate a display color of a region of an object described in this Vclick_AU. color_r, color_g, and color_b respectively designate red, green, and blue values in RGB expression of the color. color_a indicates transparency.

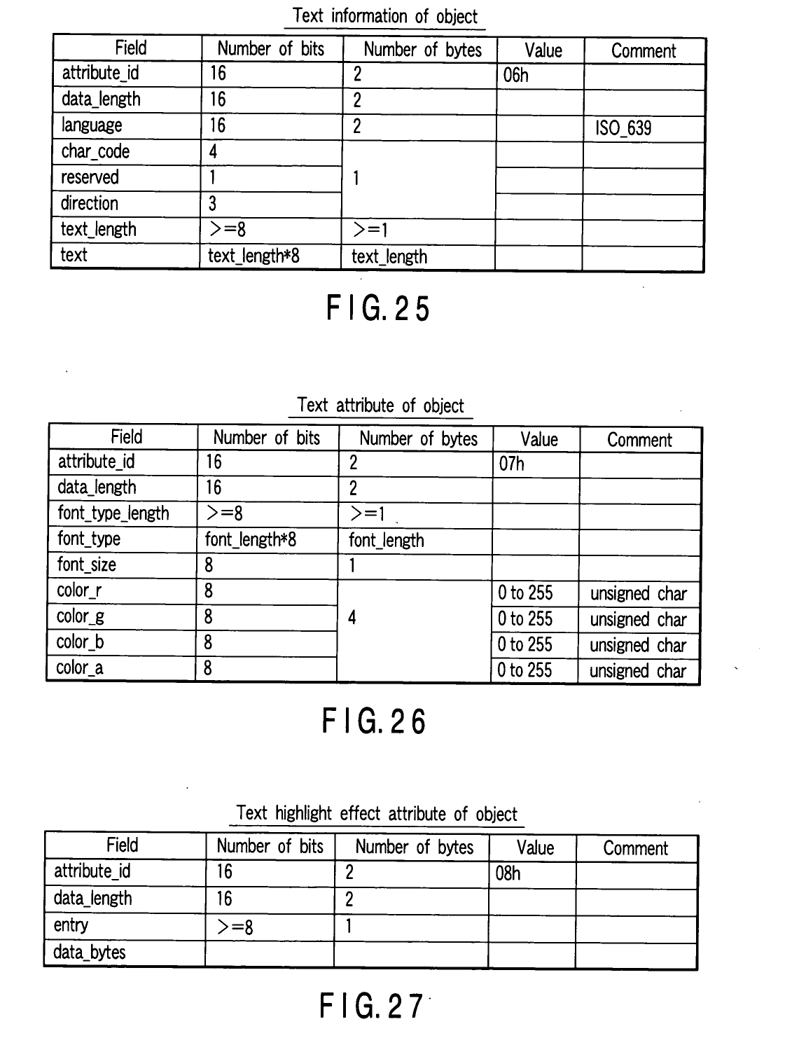

FIG. 25 shows an example of the data structure of the text information of an object. The meanings of data elements are:

attribute_id designates a type of attribute data. The text information of an object has attribute_id=06h;

data_length indicates the data length of a field after data_length of the text information of an object using bytes as a unit;

language indicates a language of described text. A method of designating a language can use ISO-639 “code for the representation of names of languages”;

char_code specifies a code type of text. For example, UTF-8, UTF-16, ASCII, Shift JIS, and the like are used to designate the code type;

direction specifies left-to-right, right-to-left, top-to-bottom, or bottom-to-top as the direction upon arranging characters. For example, in the case of English and French, characters are normally arranged in the left-to-right direction. In the case of Arabic, characters are arranged in the right-to-left direction. In the case of Japanese, characters are arranged in either the left-to-right or top-to-bottom direction. However, an arrangement direction other than that determined for each language may be designated. Also, an oblique direction may be designated;

text_length designates the length of timed text using bytes as a unit; and

text is a character string, which is text described using the character code designated by char_code.

FIG. 26 shows an example of the text attribute of an object. The meanings of data elements are:

attribute_id designates a type of attribute data. The text attribute of an object has attribute_id=07h;

data_length indicates the data length of a field after data_length of the text attribute of an object using bytes as a unit;

font_length designates the description length of font using bytes as a unit;

font is a character string, which designates a font used upon displaying text; and

color_r, color_g, color_b, and color_a designate a display color upon displaying text. A color is designated by RGB. color_r, color_g, and color_b respectively designate red, green, and blue values. color_a indicates transparency.

FIG. 27 shows an example of the text highlight attribute of an object. The meanings of data elements are:

attribute_id designates a type of attribute data. The text highlight effect attribute of an object has attribute_id=08h;

data_length indicates the data length of a field after data_length of the text highlight effect attribute of an object using bytes as a unit;

entry indicates the number of “highlight_effect_entry”s in this text highlight effect attribute data; and

data_bytes includes as many “highlight_effect_entry”s as entry.

The specification of highlight_effect_entry is as follows.

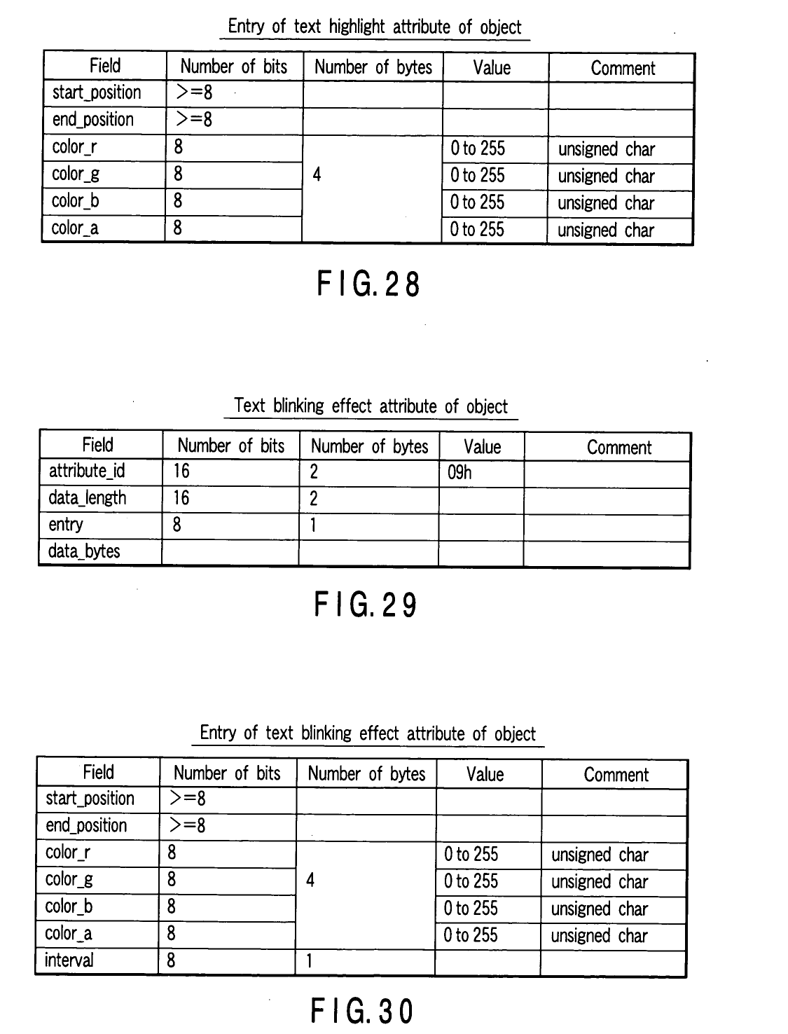

FIG. 28 shows an example of an entry of the text highlight effect attribute of an object. The meanings of data elements are:

start_position designates the start position of a character to be highlighted using the number of characters from the head to that character;

end_position designates the end position of a character to be highlighted using the number of characters from the head to that character; and

color_r, color_g, color_b, and color_a designate a display color of the highlighted characters. A color is expressed by RGB. color_r, color_g, and color_b respectively designate red, green, and blue values. color_a indicates transparency.

FIG. 29 shows an example of the data structure of the text blinking effect attribute of an object. The meanings of data elements are:

attribute_id designates a type of attribute data. The text blinking effect attribute data of an object has attribute_id=09h;

data_length indicates the data length of a field after data_length of the text blinking effect attribute data using bytes as a unit;

entry indicates the number of “blink_effect_entry”s in this text blinking effect attribute data; and

data_bytes includes as many “blink_effect_entry”s as entry.

The specification of blink_effect_entry is as follows.

FIG. 30 shows an example of an entry of the text blinking effect attribute of an object. The meanings of data elements are:

start_position designates the start position of a character to be blinked using the number of characters from the head to that character;

end_position designates the end position of a character to be blinked using the number of characters from the head to that character;

color_r, color_g, color_b, and color_a designate a display color of the blinking characters. A color is expressed by RGB. color_r, color_g, and color_b respectively designate red, green, and blue values. color_a indicates transparency. Note that characters are blinked by alternately displaying the color designated by this entry and the color designated by the text attribute; and

interval designates the blinking time interval.

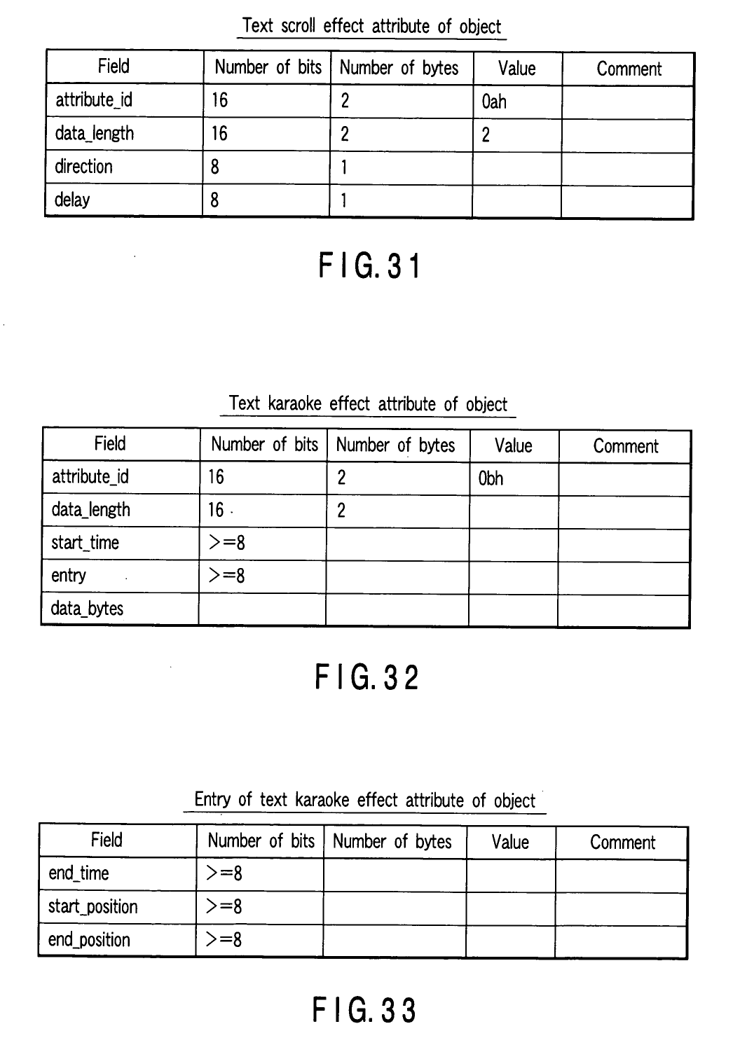

FIG. 31 shows an example of the data structure of the text scroll effect attribute of an object. The meanings of data elements are:

attribute_id designates a type of attribute data. The text scroll effect attribute data of an object has attribute_id=0ah;

data_length indicates the data length of a field after data_length of the text scroll effect attribute data using bytes as a unit;

direction designates a direction to scroll characters. For example, 0 indicates right-to-left, 1 indicates left-to-right, 2 indicates top-to-bottom, and 3 indicates bottom-to-top; and

delay designates a scroll speed by a time difference from when the first character to be displayed appears until the last character appears.

FIG. 32 shows an example of the data structure of an entry of the text karaoke effect attribute of an object. The meanings of data elements are:

attribute_id designates a type of attribute data. The text karaoke effect attribute data of an object has attribute_id=0bh;

data_length indicates the data length of a field after data_length of the text karaoke effect attribute data using bytes as a unit;

start_time designates a change start time of a text color of a character string designated by first karaoke_effect_entry included in data_bytes of this attribute data;

entry indicates the number of “karaoke_effect_entry”s in this text karaoke effect attribute data; and

data_bytes includes as many “karaoke_effect_entry”s as entry.

The specification of karaoke_effect_entry is as follows.

FIG. 33 shows an example of the data structure of an entry of the text karaoke effect attribute of an object. The meanings of data elements are:

end_time indicates a change end time of the text color of a character string designated by this entry. If another entry follows this entry, end_time also indicates a change start time of the text color of a character string designated by the next entry;

start_position designates the start position of a first character whose text color is to be changed using the number of characters from the head to that character; and

end_position designates the end position of a last character whose text color is to be changed using the number of characters from the head to that character.

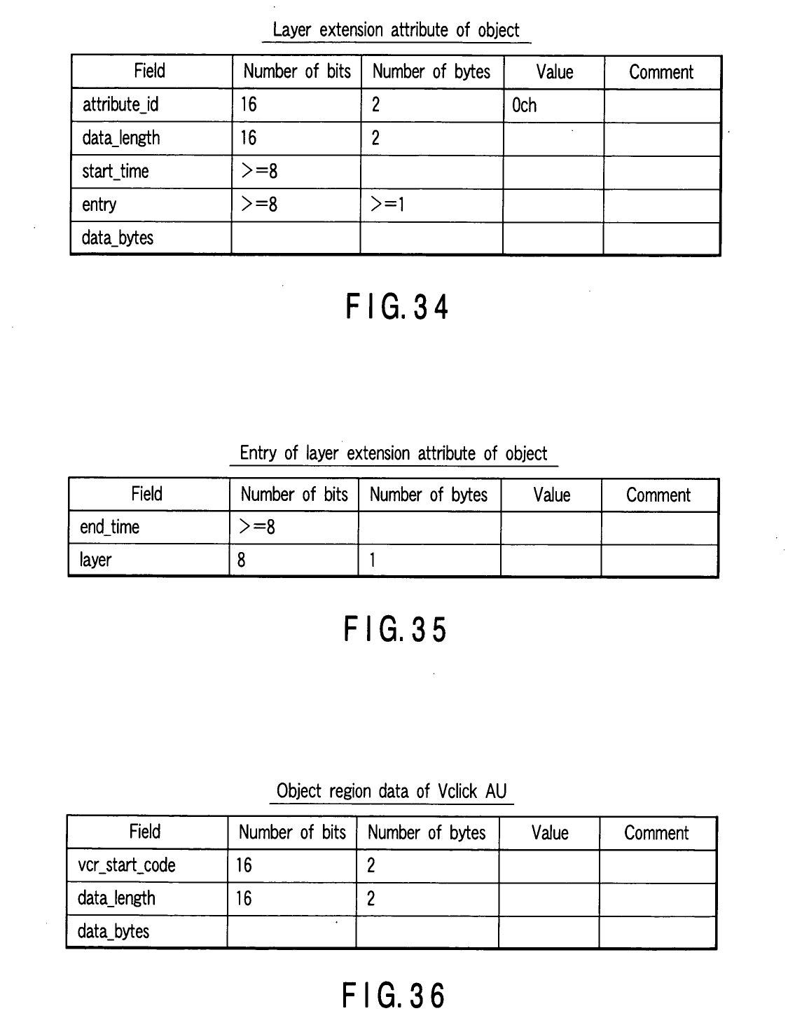

FIG. 34 shows an example of the data structure of the layer extension attribute of an object. The meanings of data elements are:

attribute_id designates a type of attribute data. The layer extension attribute data of an object has attribute_id=0ch;

data_length indicates the data length of a field after data_length of the layer extension attribute data using bytes as a unit;

start_time designates a start time at which the layer value designated by the first layer_extension_entry included in data_bytes of this attribute data is enabled;

entry designates the number of “layer_extension_entry”s included in this layer extension attribute data; and

data_bytes includes as many “layer_extension_entry”s as entry.

The specification of layer_extension_entry will be described below.

FIG. 35 shows an example of the data structure of an entry of the layer extension attribute of an object. The meanings of data elements are:

end_time designates a time at which the layer value designated by this layer_extension_entry is disabled. If another entry follows this entry, end_time also indicates a start time at which the layer value designated by the next entry is enabled; and

layer designates the layer value of an object.

FIG. 36 shows an example of the data structure of object region data 400 of object metadata AU. The meanings of data elements are:

vcr_start_code means the start of object region data;

data_length designates the data length of a field after data_length of the object region data using bytes as a unit; and

data_bytes is a data field that describes an object region. The object region can be described using, e.g., the binary format of MPEG-7 SpatioTemporalLocator.

<Summary>

An information medium (optical disc or the like) according to the embodiment of the present invention is subjected to data recording using the data structure including a stream formed by access units, each of which has metadata of a moving picture that can be played back upon playback of video content, and is a data unit that can be processed independently. The data structure is configured to include a search table used to access the metadata. With this search table, information that the user wants can be easily accessed, and information of moving picture metadata can be meaningfully utilized.

The search table can be configured to have predetermined attribute information. Using this attribute information, access to information that the user wants can be speeded up.

The search table can be configured to have a hierarchical structure. With this structure, in a search process using the search table, match search or selection search can be selected by tracing layers.

The search table can be configured to have search data in independent files (separate files). As a result, identical search data can be referred to from a plurality of positions and repetitively used, thus allowing efficient use of search data.

Note that the present invention is not limited to the aforementioned embodiments intact, and various modifications of constituent elements may be made without departing from the scope of the invention when it is practiced. For example, the present invention can be applied not only to widespread DVD-ROM video, but also to DVD-VR (video recorder), demand for which has been increasing rapidly in recent years and which allows recording/playback. Furthermore, the present invention can be applied to a playback or recording/playback system of next-generation HD-DVD, which will be prevalent soon.

Moreover, various inventions can be formed by appropriately combining a plurality of required constituent elements disclosed in the aforementioned embodiment. For example, some required constituent elements may be omitted from all the required constituent elements disclosed in the embodiment. Furthermore, required constituent elements according to different embodiments may be combined as needed.

What is claimed is:

1. An information medium which undergoes data recording using a data structure including a stream formed by access units, each of which has metadata of a moving picture that can be played back upon playback of video content, and is a data unit that can be processed independently, wherein
the data structure is configured to include a search table used to access the metadata.

2. A medium according to claim 1, wherein the search table is configured to have predetermined attribute information.

3. A medium according to claim 1, wherein the search table is configured to select match search or selection search, and to have a hierarchical structure.

4. A medium according to claim 1, wherein the search table is configured to search data in independent files.

5. A playback apparatus configured to play back the video content from the information medium of claim 1, and to play back the moving picture metadata as needed.

6. A method using a data structure including a search table and a stream formed by access units, each of which has metadata of a moving picture that can be played back upon playback of video content, and is a data unit that can be processed independently, wherein
the method is configured to access the metadata using the search table.
